(19) United States
(12) Patent Application Publication
(10) Pub. No.: US 2006/0059032 A1
(43) Pub. Date: Mar. 16, 2006

(54) System, computer program product, and method for enterprise modeling, temporal activity-based costing and utilization

(76) Inventors: Kevin Nelson Wong, Toronto (CA); Kokchu Donald Tham, Thornhill (CA); Jason Dean Tham, Thornhill (CA); Sean Sebastian Kirby, Wawa (CA); Jason Andrew Yuen, Etobicoke (CA)

Correspondence Address: MILLER THOMPSON, LLP, 20 QUEEN STREET WEST, SUITE 2500, TORONTO, ON, M5H 3S1, CA

(21) Appl. No.: 10/931,031

(22) Filed: Sep. 1, 2004

(51) Int. Cl. G06F 17/30; G06Q 99/00; G07G 1/00

(52) U.S. Cl. 705/10; 705/1

(57) ABSTRACT

A method of temporal, activity-based cost modeling for an organization is provided. The method includes the steps of (a) determining a plurality of data types contributing to costs related to one or more activities of the organization; (b) capturing data elements corresponding to the data types; (c) Creating an ontological enterprise model based on the data elements, by applying a Temporal Activity Based Costing Model to the organization; testing the applicability of the Temporal Activity Based Costing Model to the organization; and adjusting the Temporal Activity Based Costing Model to the organization, based on the testing; and (d) configuring a computer system to apply the ontological enterprise model to the data elements on an ongoing basis, such that the ontological enterprise model yields information about the costs of the activities for defined periods of time. The method enables derivation of cost knowledge from the cost information, by operation of a profit knowledge utility. A series of sub-methods are also provided to enable the application of the Temporal Activity Based Costing Model. A computer system and computer program is also provided for implementing the temporal, activity-based cost modeling of the invention for an organization. The invention also provided for temporal, activity based billing, and generation of real time temporal cost information.

### FIELD OF INVENTION

This invention relates in general to systems, computer program products and methods for optimizing the use of resources in enterprises, including businesses, not-for-profits and governmental organizations. This invention relates more particularly to a system, computer program product and method for modeling, costing, valuing, and optimizing an enterprise using an activity-based costing model.

### BACKGROUND OF INVENTION

Enterprises whether commercial, non-profit or governmental, require numerous resources to undertake their activities. These resources include money, raw materials, personnel, real estate, energy, equipment and so on. These resources are finite, or in other words have an associated cost. Therefore in order to operate efficiently, it is desirable for enterprises to utilize these resources efficiently. In particular, a for-profit business can achieve significant improvements to its profitability if it enhances its resource utilization, and uses costs to make decisions about continuous improvement, and pricing of products and services. Although valuable to all businesses, such improvements are most critical to business success in industries where margins are thin, variable and overhead costs are dominant, operations change frequently, and many customers are served. The third-party logistics industry is a good example of this type of business.

A number of costing techniques have been developed over the years to try to provide business managers with better insight into their operational cost structure.

In the past, direct material and labour were the primary costs associated with producing a product or providing services, and associated overhead and administrative costs were relatively small. With this the case, it was possible to reasonably determine costs by examining basic accounting records such as the general ledger for salary and raw material figures. Sales prices could then be determined with the traditional approach of adding a desired margin onto the operational costs.

With the widespread adoption of automation and technology in production environments, this method of costing became inadequate because the indirect costs associated with production became relatively large. In order to continue attributing costs in accounting records to particular products, a methodology was needed that could accurately associate indirect costs to specific operations. In the early 1980s a system called Activity-Based Costing (ABC) gained attention for its ability to address this problem, and proponents of ABC have extolled its benefits for enabling process improvement, strategic decision-making, and solving other problems that depend on knowledge of costs. Computer systems have been developed based upon these ABC concepts with the intent of helping businesses understand and make decisions based upon the costs yielded from these systems.

Yet these systems remain very limited because of their dependence on ABC principles, which still have many inherent problems.

The principle of ABC involves the assignment of costs to activities based on their use of resources, and the assignment of costs to end products and services based on their use of activities. Since the ABC methodology assigns costs to activities based on their use of resources, it is premised upon the existence of some given or identifiable cost associated with each of these resources. Problems with this premise are encountered because within this paradigm, there is no way of exactly determining resource costs within the enterprise. These costs can only be estimated. As well, allocation of direct and indirect overhead costs to these activities is performed through activity and resource drivers in cost pools. In most situations, many different drivers can be picked, and consequently costs are only as good as the drivers selected, and change along with these drivers.

The following example demonstrates the drawbacks of traditional ABC cost methodologies and traditional activity-based costing methodologies. Consider Company X with the following data:
Produces 100 units of product A and 500 units of product B for year
Direct labour: Product A is 3 hours; Product B is 2 hours
Labour cost: $20 per hour and total labour hours is 2000 hrs per year
Total overhead cost per year is $100,000
Cost of overhead (O/H)=$100,000/2,000 hrs=$50/hour
Activities required for each of products A and B are: Setup, Machining, Receiving, Packing, Engineering

FIG. 1 shows a tabular view of the product costs derived using the traditional cost accounting method. Using this methodology, Product A appears to cost more than Product B. FIG. 2 then shows the change in costs once an Activity-Based Costing methodology is used. Now Product A costs less than Product B. FIG. 3 then shows how the costs change with the same data, but using different, but equally realistic, cost drivers. Now both the cost of Product A and the cost of Product B have changed again. This is a demonstration of how costs yielded from ABC-based systems can be inconsistent, and do not relate to operations in a definitive manner.

Further to these problems, conventional costing methodologies do not properly account for changes in cost over time, and lack a method by which a consistent representation of operations can be obtained. While the first shortcoming leads to inaccurate costing, the latter means that systems using conventional costing paradigms facilitate primarily aggregate knowledge of cost and profit, and are limited in their ability to support continuous improvement and decision-making activities.

A prior art publication that explores these problems is the doctoral thesis of Dr. Kokchu Donald Tham, entitled Representing and Reasoning About Costs Using Enterprise Models and ABC. Dr. Tham's thesis advances a “cost ontology for enterprise modeling and a Theory of Resource Cost Units”. The former describes a formalized manner of modeling an enterprise, and the latter consists of a series of related rules and calculations for determining costs in an enterprise modeled in this manner. These concepts together enable operations-based allocation of variable costs to particular activities over time, including but not limited to overhead.

The cost ontology for enterprise modeling allows for a valuable visualization of operations, while the inherent explicitness of the ontology replaces the uncertainty of overhead allocation with clear, well-defined relationships. The theory of resource cost units in the thesis also expands upon the notions of internal and external resources developed in the cost ontology. In a properly constructed model, this theory describes how the cost of internal resources can be derived unambiguously from the costs of external resources. As well, when employed in combination, the cost ontology and theory of resource cost units accommodate the effect of time on costs, which is missing in other conventional costing methodologies.

However there are still a number of practical disadvantages to Dr. Tham's prior art solution. One such disadvantage is that the rules and calculations he used to derive costs included errors and inconsistencies which lead to reduced accuracy in costing. As well, it suffers from many practical limitations because it is time consuming to identify the data needed for the cost ontology, to then acquire the data, and to then perform the calculations on the data. In addition, errors are easily introduced and hard to find in this prior art. This limits the application of Dr. Tham's prior art to smaller projects, and precludes its use in real-time operational situations.

As well, in order to implement activity-based modeling in the commercial context, it was found that a computer system was required in order to provide the ability to make decisions based on the costing output on-demand. Effective provisioning of this costing output, and its related utilization, required a new system, computer program product and related method.

In order to address the limitations of Dr. Tham's prior art, and of existing systems developed based upon conventional costing paradigms, there is a need for a system, computer product and method for enabling Enveloped Activity-Based Enterprise Modeling, and Temporal Activity-Based Costing in an enterprise by operation of a new improved method. There is a further need for a deployment procedure for such a system, computer product and method for enabling temporal activity based costing in an enterprise that is efficient and cost effective.

### BRIEF DESCRIPTION OF THE DRAWINGS

A detailed description of several embodiments is provided herein below by way of example only and with reference to the following drawings, in which:

FIG. 1 shows an explanatory example of product costing using the traditional cost accounting method.

FIG. 2 shows an explanatory example of product costing using Activity-Based Costing with a first set of drivers.

FIG. 3 shows an explanatory example of product costing using Activity-Based Costing with a second set of drivers.

FIG. 4 shows a system model of the problem domain of the invention. The model illustrates the inputs, outputs, parameters and byproducts of the desired invention.

FIG. 5 is a combination of FIGS. 5A, 5B, 5C, and 5D which describe the Design For Temporal-ABC (“DFTA”) method of the invention.

FIG. 6 shows a high-level architectural view of the computer system of the invention.

FIG. 7 shows a system diagram illustrating one particular embodiment of the system of the present invention in an implementation in an operational environment.

FIG. 8 shows Sub-process I of the method of the present invention.

FIG. 9 shows a representative system interface for the computer system showing different aspects of the modeling facility as they would appear together. It shows the key elements of the interface, such as the menu bar and tool bar for issuing commands, the EABEM Editor for creating and managing the visual enterprise model, the property pages, or views, for displaying supplemental information or providing additional functionality.

FIG. 10 illustrates the ontological relationship between an Activity, and its associated State Junctions, State Blocks, and Resources. A grouping of entities in this fashion is called an Activity cluster. A visual enterprise model, or EABEM model of the present invention, is typically composed of many Activity clusters joined together.

FIG. 11 shows a sample property page that would allow management of Non-Period Resource entities, where no pro-rating is needed. The Total Quantity and Total Cost fields are used to determine the unit cost.

FIG. 12 shows a sample property page that would allow the pro-rating of Period Resource entities. The cycle duration, cost per cycle, and resource usage fields are used specifically for the prorating.

FIG. 13 shows a sample property page that would allow management of State Block entities. There would be a field for specifying its relationship with a Resource, its data type, and its specification.

FIG. 14 shows a sample property page specifically for setting the temporal properties of a State Block.

FIG. 15 shows a sample property page that would allow management of a State Junction. It has a field for specifying the relationship with its Activity, and what type of State Junction it is.

FIG. 16 shows a flowchart describing Sub-process II, by which a user creates a visual enterprise model, or EABEM, in a system of the present invention. “Place” and “connect” actions would be performed in the EABEM editor, while “set” actions would be performed in the property pages as described above. This flowchart assumes the data necessary to populate the model has been collected from the operational systems through the methods described later.

FIG. 17 shows a flowchart describing Sub-process III, by which a user populates the temporal data of an EABEM.

FIG. 18 shows a sample property page that would allow the querying of the EABEM model to obtain cost information about an Activity, given the specification of certain parameters that we are now querying, such as time.

FIG. 19 shows a sample property page that would allow the querying of the EABEM model to obtain cost information about a Resource, given the specification of certain parameters, such as time, and the Activity with which respect to which the cost is desired.

FIG. 20 shows the acceptable State Block-Resource (CC4) connection scenarios.

FIG. 21 shows how State Junctions can be initially connected to other State Junctions (CC2) prior to auto-morphing behavior.

FIG. 22 shows the resulting connections when connection class 2 (CC2) auto-morphing converts non-directed acyclic and cyclic graphs to directed acyclic graphs upon the connection of an Activity to the State Junction entities.

FIG. 23 shows how a non-directed cyclic graph is converted into a directed cyclic graph with an illustration of the connections before and after auto-morphing.

FIG. 24 shows a diagram illustrating data populated to the visual enterprise model of the present invention in regard to responsibilities within a particular Activity cluster.

FIG. 25 shows three illustrative timeline examples for the explanation of Non-Period Resource Status costing.

FIG. 26 shows an illustrative timeline example for the explanation of Period Resource Status costing.

FIG. 27 shows a sample property page that the user would use to define workflows in an EABEM through the addition of Activities, and setting of an input resource.

FIG. 28 shows a simplified view of an Activity cluster (without state entities) which is used as an illustration for the explanation of temporal data population in real-time.

FIG. 29 shows a timeline corresponding to the Activity cluster in FIG. 28 for further illustration of temporal data population.

FIG. 30 shows a sample property page that would show the user errors and warnings encountered during the modeling or costing process. Validation errors would show up on this property page for example.

FIG. 31 shows a scenario with two reporting periods for two different customers that is used to help explain how the period of study is determined when costing Period Resources in real-time.

FIG. 32 shows the scenario with given Period Resource costs in the two reporting periods, and the resultant costs using a naïve approach to determining the period of study.

FIG. 33 shows an illustrative example of how periods of study would be determined based upon reporting periods for a particular Period Resource.

FIG. 34 shows the same scenario as presented in FIG. 31 but with Period Resource costs derived using periods of study based upon reporting period completion times.

FIG. 35 shows a timeline that describes how periods of study are determined for incomplete reporting periods.

FIG. 36 shows how Period Resource unit costs derived using temporary periods of study can differ from those derived once the period of study finally becomes fixed.

FIG. 37 shows an EABEM and corresponding Resource State timeline that together create a branch reach back situation.

FIG. 38 shows an illustrative example of how costs are allocated for periods of study that have zero-usage of a Period Resource.

FIG. 39 shows a graphical representation of how inventory data can be used to determine Activity durations in situations where these durations are longer than the Period of Study.

FIG. 40 shows a representative illustration of a typical data mart included in the data warehouse as part of the data storage facility of the present invention.

FIG. 41 is a sample property page that would allow the user to assign Activities to be part of certain Value Added Service (VAS) groupings. These would be used in the billing facility as the basis from which costs and markups are assigned to customers in the billing process.

FIG. 42 shows how an Activity Group such as a VAS is defined by Activities and Resources in an EABEM.

FIG. 43 shows how transactional operational data for Activities are matched to Activities in VASs.

FIG. 44 shows three VAS arrangements which are disallowed in the computer system.

FIG. 45 shows a conceptual representation of how an EABEM workflow is comprised of VASs and Activities.

FIG. 46 shows a portion of an EABEM that is used to help illustrate how the algorithm for solving the VAS isolation problem works.

FIG. 47 is a sample interface of the Billing Facility which would allow the user to manage rules. There is an aspect which would allow the management of all the created rules, and an aspect which would allow the creation and removal of rules, and modification of the rule properties, such as their trigger conditions and actions.

FIG. 48 is a sample interface showing how the user could create and manage charge guards. The interface would allow the user to set maximum or minimum guard action, or alternately a fixed charge action. Charge guard rules could trigger on conditions just as would normal rules.

FIG. 49 shows a flowchart describing the process by which the rule inference engine is used in the billing facility to generate cost-based charges for an invoice.

FIG. 50 is a sample interface showing how invoice data could be displayed to the user. There is an aspect which would allow the management of all the created invoices, and an aspect which would provide summaries of the invoice details as a form of preview prior to issuing of the invoice.

FIG. 51 is a flowchart illustrating the operation of the reporting facility in the present invention. It details how a report can be created through the definition of metrics and filters. These definitions would be performed through the interface to the computer system.

FIG. 52 shows a sample interface which would allow the user to choose metrics to be used in the report that is being built. Metrics can be chosen from a list of existing metrics, or the user can opt to define a new metric.

FIG. 53 shows a sample interface which would allow the user to define a new metric composed of predefined numerical metrics, and numerical operators. Metrics defined here can be selected through an interface such as the one shown in FIG. 52.

FIG. 54 is a sample interface which would allow the user to specify filters that can limit the results of the report to only those concerns. Filters are created by specifying conditions on the selected metrics which must be satisfied for the result to appear in the report.

FIG. 55 is an example of a report that would result from the application of the process described in FIG. 51. This is just one example of a report, although many various types of reports could be made by following this process.

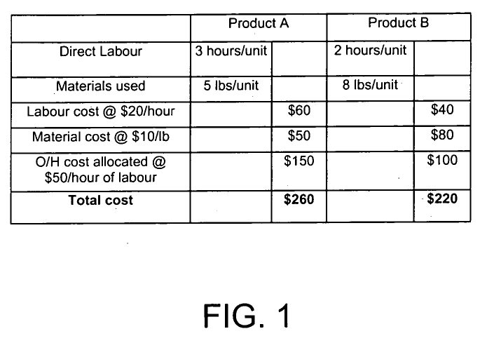

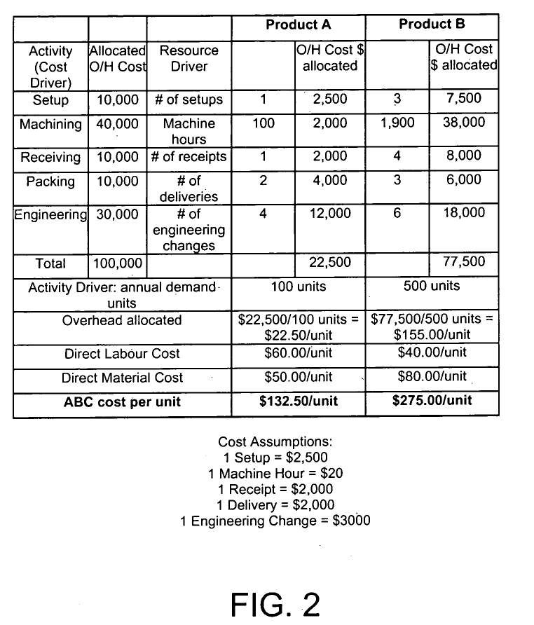

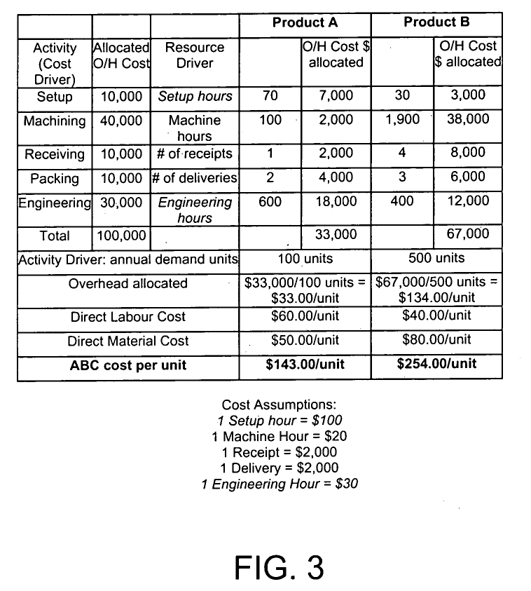

In the drawings, preferred embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

The present invention comprises a method and computer system that addresses the accuracy, consistency, and utility challenges of conventional costing systems and methodologies.

This invention addresses the fact that it is difficult to get cost information efficiently and cost effectively in a practical setting by providing a formalized method for gathering this cost data and capturing it in a fashion which is utilitarian for a business user. A computer system is also part of the invention because without such a system, this method would be very time-consuming, liable to introduce errors, and difficult to apply to large enterprise processes.

Enterprises typically have immense volumes of operational data, from different activities, at different times, and from a variety of operational systems, not all of which is relevant to costing. There can be challenges identifying what data is preferred to answer cost-related problems, having an effective manner of capturing this data, and accommodating scenarios where not all of the necessary data is available. The method of the invention includes a process by which this necessary data can be identified consistently, and the computer system part of the invention includes an aspect that can handle the extraction of large volumes of data identified as relevant, and the derivation of necessary but unavailable data.

Data can only be turned into information once relationships and context are provided for the data. Once the correct data is identified and gathered, it still must be organized into a representation that yields information about cost in the enterprise. It is not obvious how to properly create an ontological enterprise model of this type correctly and efficiently. Preferably, this is accomplished in accordance with a systematic process for model development (particularized below), and the use of a computer system visualization of the enterprise and associated data.

Once an ontological model is created in accordance with one aspect of the invention, costs must be determined based on the information in the model. This is a challenging task for anyone to perform accurately, consistently, and comprehensively, and especially on-demand in a real-time operational environment. Existing costing systems and approaches struggle to achieve these goals, and have flaws in their calculations. This invention describes a methodical process and a supporting computer system and computer program that can enforce the rules and apply the calculations in an automated fashion to make this type of costing possible.

One drawback of existing costing systems is that the cost results they yield have very limited use because they are invariably aggregate results, and hard to correlate with actual operational processes. In recognition of this, another novel aspect of the invention describes how to utilize the cost results of the invention as the basis for more advanced applications, such as continuous improvement, reporting, decision-making, and product and service pricing activities. The invention can also function as a historical, predictive, and especially unique, real-time costing apparatus.

In accordance with one aspect of the present invention, there is provided a method of temporal, activity-based cost modeling for an organization comprising the steps of: determining a plurality of data types contributing to costs related to one or more activities of the organization; capturing data elements corresponding to the data types; creating an ontological enterprise model based on the data elements, by: applying a Temporal Activity Based Costing Model to the organization; testing the applicability of the Temporal Activity Based Costing Model to the organization; and adjusting the Temporal Activity Based Costing Model to the organization, based on the foregoing; and configuring a computer system to apply the ontological enterprise model to the data elements on an ongoing basis, such that the ontological enterprise model yields information about the costs of the activities for defined periods of time.

In accordance with another aspect of the present invention, there is provided a method of temporal, activity-based cost modeling for an organization comprising the steps of: conducting an organization review including one or more of the following steps: identifying organization/customer costing requirements and business objectives; identifying products or services of interest so as to establish a plurality of cost objects; identifying a plurality of stakeholders within the organization, including organization personnel, suppliers, and/or organization clients, and obtaining from the plurality of stakeholders feedback regarding one or more of project risks, limitations, current costing practices and a project plan; and cataloguing a plurality of activities of the organization; establishing a plurality of criteria for assessing the success of the temporal, activity-based cost modeling, such criteria including one or more of competency questions, continuous improvement metrics, and the influence of each of these on organization performance; probing the plurality of activities so as to identify a plurality of data types contributing to costs related to the plurality of activities; coordinating access to the data types from one or more data sources, so as to enable access to temporal data corresponding to the data types; creating an ontological enterprise model for enabling the analysis of the temporal data by: applying a Temporal Activity Based Costing Model to the organization; populating the Temporal Activity Based Costing Model with the temporal data; and performing forensic analysis on the populated Temporal Activity Based Costing Model, and testing and validating the Temporal Activity Based Costing Model; and configuring a computer system to process the temporal data in real time based on the Temporal Activity Based Costing, thereby generating real time costing information.

In accordance with a further aspect of the present invention, there is provided a computer system for enabling temporal, activity-based cost modeling comprising: a computer; and a computer application loaded on the computer, the computer application including computer instructions for defining on the computer system a profit knowledge utility, the profit knowledge utility being operable to: process data elements corresponding to a plurality of data types contributing to costs related to one or more activities of the organization, so as to create an ontological enterprise model based on the data elements, by: applying a Temporal Activity Based Costing Model to the organization by means of a modeling utility; enabling a user to test the applicability of the Temporal Activity Based Costing Model to the organization; and further enabling the adjustment of the Temporal Activity Based Costing Model to the organization, based on the foregoing; and applying the ontological enterprise model to the data elements on an ongoing basis, such that the ontological enterprise model yields cost information regarding the costs of the activities for defined periods of time.

According to yet a further aspect of the present invention, there is provided a computer program for enabling temporal, activity-based cost modeling comprising, for use on a computer, the computer application comprising: a computer useable medium; and computer instructions on the computer useable medium, such computer instructions being operable on the computer to define a computer application that includes a profit knowledge utility, the profit knowledge utility being operable to: process data elements corresponding to a plurality of data types contributing to costs related to one or more activities of the organization, so as to create an ontological enterprise model based on the data elements, by: applying a Temporal Activity Based Costing Model to the organization by means of a modeling utility; enabling a user to test the applicability of the Temporal Activity Based Costing. Model to the organization; and further enabling the adjustment of the Temporal Activity Based Costing Model to the organization, based on the foregoing; and applying the ontological enterprise model to the data elements on an ongoing basis, such that the ontological enterprise model yields cost information regarding the costs of the activities for defined periods of time.

### DETAILED DESCRIPTION OF THE PREFERRED EMBODIMENT

The present invention is based on the concepts of an “Enveloped Activity. Based Enterprise Model” or “EABEM” model, and “Temporal Activity-Based Costing” (or “Temporal-ABC” or “T-ABC”), which originate from concepts described in the cost ontology and theory of resource cost units put forth by Dr. Tham's thesis, but also include some novel improvements and corrections. This model and these concepts are explained by reference to specific examples below. The present invention permits the effective application of these concepts in an operational setting, by overcoming a number of procedural and technical challenges in unique ways.

Method and System Overview (Section I)

EABEM and Temporal-ABC principles are leveraged in the present invention by an integrated process aspect, called the Design For Temporal-ABC (DFTA) method, and computer system aspect that together provide more accuracy, consistency, and utility than conventional costing systems and methodologies.

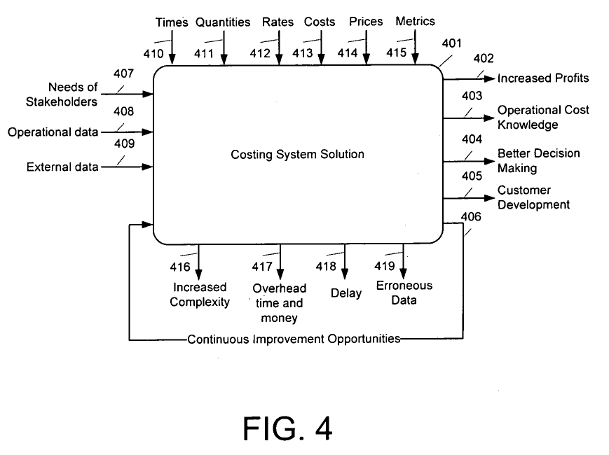

FIG. 4 provides an exemplary system view of the problem which the invention solves.

The system solution is contained in 401. The outputs are the results desired from the system. The representative outputs 402-406 are results or activities that are useful for business, which are achieved because of the system. If the outputs are the reason for using the system, what is required by the system is described by the inputs 407-409. The parameters 410-415 provide an idea of how the inputs need to be described in the system of the present invention. The system also has undesirable side-effects 416-419 which should be minimized by the system.

The present invention is a novel system solution 401 comprised of a method and computer system that can address the general challenge of achieving the outputs 402-406 by translating the inputs 407-409 in manner that is more accurate, consistent, and efficient than other systems. Other systems involve significantly greater side-effects, do not have all the necessary inputs or parameters, and/or cannot produce the outputs successfully.

One aspect of the method described in this invention consists of a particular application of EABEM and Temporal-ABC concepts to real-world enterprises. This aspect of the invention consists of a particular method formalized method for efficient application of EABEM and Temporal-ABC concepts consisting of, modeling and costing the enterprise using EABEM & Temporal-ABC, and then utilization of the results for tangible and sustained benefits for a real business (greater particularity below).

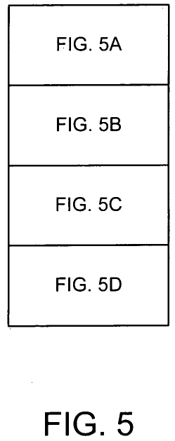

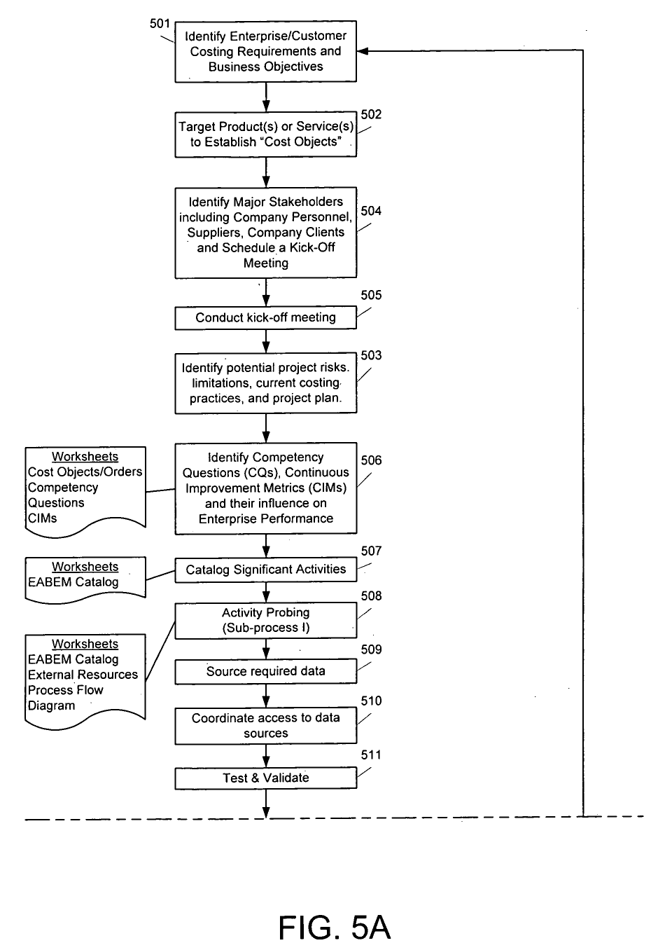

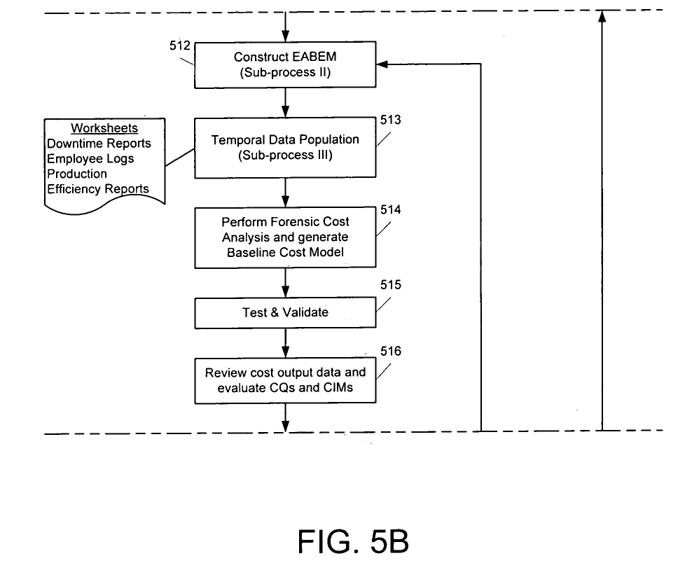

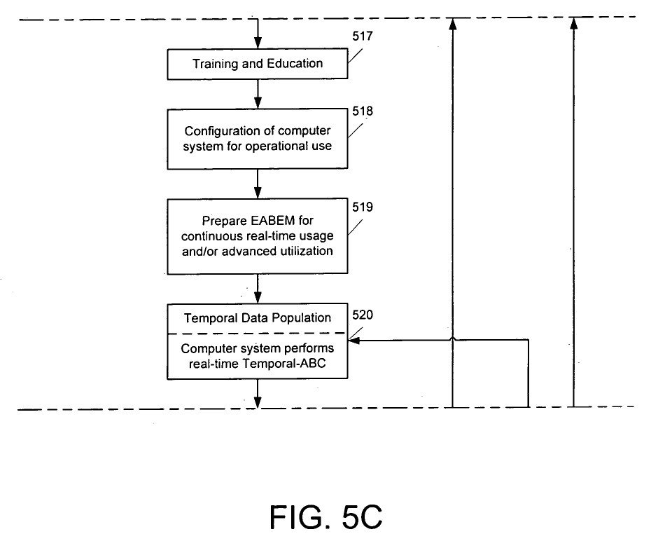

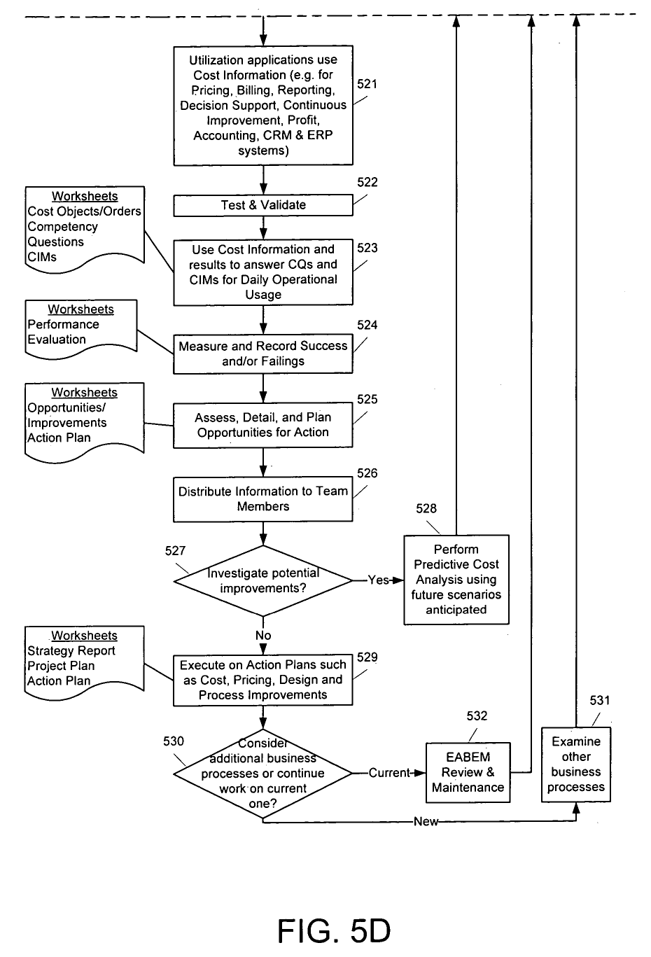

The overall method is best understood by reference to FIGS. 5A, 5B, 5C, and 5D. The method is comprised of five phases which present the method of the present invention and also processing steps defined by the method computer system. The phases are: Preparation 501-511, Modeling 512-516, Costing 517-520, and Utilization 521-532.

The details of each phase will be explored in greater detail sequentially through the detailed description of the invention. A general description of the method during each phase goes as follows:
1) Preparation: where preparatory work such as planning and background research is performed.
2) Modeling: where information relevant to the EABEM is identified and gathered, and model appropriateness is tested.
3) Costing: where configuration and training for the operation of the computer system is performed.
4) Utilization: where cost information and results are interpreted to evaluate performance, make decisions, and create plans for improvement actions.

Furthermore, preferably a computer system is used within the framework of the method because without it the capabilities of the method to yield valuable results are somewhat limited. The reason for this limitation is twofold. First, there are practical limitations to employing the EABEM and Temporal-ABC concepts manually, such as the slow speed at which calculations and repetitive tasks are performed, the likelihood of introducing inaccuracies due to human error, and the inability to manage the vastness and complexity of real-world enterprise models. Second, a computer system can readily leverage data already available in existing enterprise computer systems, a great deal of which is necessary to yield proper models and costs.

A general description of the use of the computer system during each phase goes as follows:
1) Preparation: assessment of relevant data, their availability, and how to extract the data from their sources
2) Modeling: where the EABEM model is first constructed in the computer system, and validated
3) Costing: where the computer system accepts data from one or more data source to perform automated costing using Temporal-ABC techniques,
4) Utilization: where cost information and results are leveraged by other aspects of the computer system for purposes such as billing, reporting, decision-support, continuous improvement, accounting, etc.

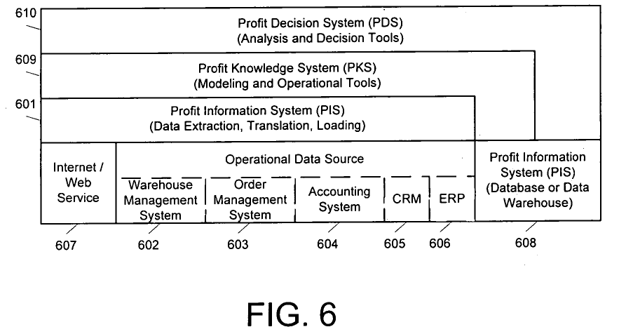

The computer system aspect of the invention is best understood by reference to FIG. 6 which illustrates the high-level architecture of the system of the present invention wherein the shaded boxes represent aspects of the invention, and the unshaded boxes represent aspects which are not part of the computer system of present invention, but which might interact with the invention.

However, should be understood or may be linked to the Profit Information System (PIS) 601 aspect of the invention handles data extraction translation and loading to and from operational data sources such as those represented by 602-606 or external data sources such as the Internet 607. These data sources generally consist of known databases and related utilities that enable access to the data described. In one embodiment, a database or data warehouse 608 would also be part of the PIS 601 for persistence of cost information and results for later retrieval and utilization.

The PIS is best understood as a profit knowledge utility with the attributes described in the present invention, running on a computer.

The Profit Knowledge System (PKS) 609 takes the basic cost information made available by the PIS 601 and represents it as cost knowledge through the use of the modeling and costing facilities of the computer system.

The PKS is best understood as a profit knowledge utility with the attributes described in the present invention, running on a computer.

The PKS also includes other operational tools, for example the billing facility, which uses the cost knowledge to produce cost-based bills. The Profit Decision System (PDS) 610 takes the knowledge from the PKS 601 further by allowing it to be queried and analyzed for more strategic applications such as decision support and continuous improvement.

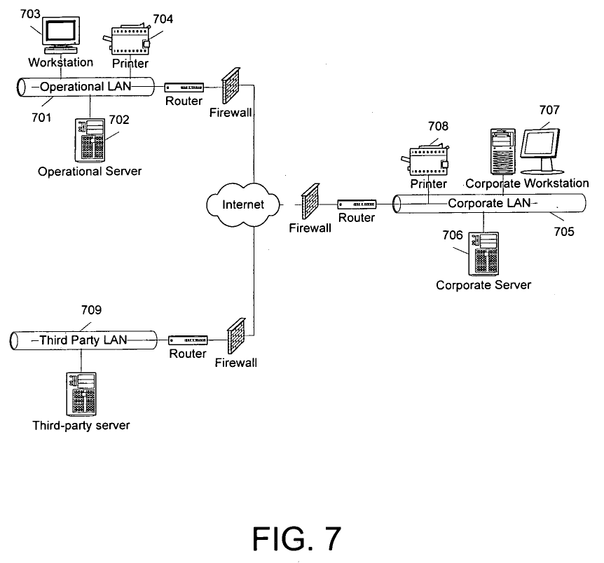

An illustration of the implementation of the present invention is use by a value-added warehousing enterprise. This example is carried throughout the detailed description as a representative use case for the invention. It should be understood, however, this example can be used to describe the architecture of the computer system aspect of the invention as depicted in FIG. 7. Although the computer system can be manifested using many different architectures, particularly when considering a web-based architecture in the heterogeneous Internet environment, a client-server model is depicted in FIG. 7 as a representative architecture for the computer system aspect of the present invention. Conversion into other architectural designs such as a web-based architecture can then be performed in a manner that is known. FIG. 7 shows three Local Area Networks (LANs) connected to the Internet by routers through firewalls. The Operational LAN 701 in the warehousing example would be in the warehouse itself, with a server running an operational system 702 such as a Warehouse Management System (WMS) and storing information in an operational data source e.g. a database. The LAN in the warehouse would generally include one or more workstations 703 and peripheral devices such as printers 704, which users in the warehouse could use to manage operational activities, including the WMS. The Corporate LAN 705 is where the corporate systems 706 such as an Accounting System or Enterprise Resource Planning system might be running. As in the warehouse, the corporate LAN would support workstations 707 and peripherals 708. The computer system of the present invention could reside on either the operational server 702, or the corporate server 706, or on a separate server altogether either on the operational or corporate LAN. Management of the computer system could also, be performed from a client workstation connected to either of the LANs. These architectural decisions would depend primarily on the needs and existing infrastructure of the enterprise. The Third-Party LAN 709 is connected to the other LANs over the Internet as well. This LAN could be a service provider for the enterprise, or a customer for the enterprise. The third-party LAN could interact with the other systems in numerous ways such as providing the corporate Enterprise Resource Planning system with information via Electronic Data Interchange, by providing the operational server with customer order information, or by providing relevant data (for example fuel prices) to the computer system of the present invention for its more advanced facilities.

One embodiment of the computer system involves its implementation using an imperative programming language. The thesis of Dr. Tham presented temporal activity-based costing concepts in axiomatic form. These axioms lend best to implementation in a computer system using a declarative language such as PROLOG™. However declarative languages are not as widely used as imperative languages, particularly object-oriented ones such as Java, which are superior for building most commercial computer systems today. Among their advantages are generally faster performance, greater understandability and maintainability, much greater developer base, better tool support, more powerful and faster evolving languages (particularly for user-interface development), and greater interoperability with other software and hardware. In order to capitalize on these advantages, the computer system aspect of the invention converted the axioms of Dr. Tham's thesis into a costing facility that could be implemented in an imperative language.

Data Identification and Capture (Section II)

While cost information is much sought after by business managers, the method described in the present invention provides a particular method for obtaining temporal ABC information and is the first to describe how Temporal-ABC information can be obtained with consistent success. This method reduces the need for the time-consuming and subjective debates which often inhibit effective deployments of traditional activity-based costing systems in the early stages of the project.

The Preparation phase shown in FIG. 5A involves the gathering of enterprise costing requirements and business objectives 501 and identification of cost objects (particularly final products or services that are to be studied) 502, including the understanding of present costing practices within the organization (e.g. traditional or cost accounting) 503. Achieving project support from all stakeholders is key to the success of the DFTA process, which generally gives rise to steps 504 and 505 which involve a team (DFTA Team) with diverse backgrounds from within the company, and may also include outside implementation consultants to support the Temporal-ABC project that offer their relevant experience. Company employees may include C-level managers, middle-level managers, IT/system administrators, etc. The Temporal-ABC system provider may offer a T-ABC/EABEM specialist, deployment prime, industry consultant (to provide the enterprise with further industry expertise), etc. Starting in the Preparation phase and continuing throughout the method, the DFTA team will generally be responsible for completing the relevant worksheets throughout the implementation process, and help to ensure a successful Temporal-ABC system deployment and provide ongoing maintenance. All members must be willing to participate in the DFTA process and be empowered to act.

An example of DFTA Team Requirements and Profiles might go as follows:

Financial Controller:

Has detailed understanding of financial structure of the enterprise
Contribute to development of CQs, CIMs, and business objectives
Define utilization requirements and report structure
Determine support and integration required for existing financial cost accounting procedures and systems
Provide and detail the actual costs incurred within the enterprise to help populate EABEM model with cost data
   Purchasing Representative:
Responsible for the purchasing of raw materials, equipment and other resources within the enterprise
Familiar with purchasing and resource requirements for activities performed within enterprise
   Process Facilitator:
Provide communication flow within the team
Temporal-ABC system representative or Temporal-ABC consultant
This person requires a solid background in EABEM, T-ABC and ideally process engineering or continuous improvement methods
Be responsible for preparing DFTA packages before each meeting
Will be present at every DFTA meeting
   Product Manager:
Communicate Temporal-ABC system features
Ensure system features fulfill enterprise's cost requirements
Educate enterprise on the implementation, utilization, maintenance of the Temporal-ABC system
Will be present at every DFTA meeting
   Project Manager:
Responsible for the implementation of new processes for new clients
Helps with the quotation and pricing of new project implementations
Provide technical experience of the products and services under study
   Operations Manager:
Provides experience on the operations and procedures performed within the enterprise
Should also be involved in developing the meeting packages
Will be present at every DFTA meeting
   IT Administrator/Personnel:
Provides technical support for the administration and ultimately the operational deployment of the Temporal-ABC system
Provides insight and guidance as to where and how to access the data required for the Temporal-ABC system

The Preparation phase also involves work with the computer system in preparation for the Modeling and Costing Phases to come (particularized below). It is possible to have an implementation of the present invention which could capture all of the data necessary for later phases of the method, by extensively and rigorously using known data gathering technologies such as bar-coding, RFID, and voice-instruction. However modern enterprises typically have much of this data available already, often generated in a transactional form and buried amongst immense amounts of other data from their operations. Although not necessary, it is more economical to utilize this existing infrastructure to obtain the data necessary for the EABEM and Temporal-ABC concepts to be used. Also during this Preparation phase, Competency Questions (CQs) and Continuous Improvement Metrics (CIMs)—which help identify improvement opportunities in the enterprise—are identified and documented in worksheets to further clarify the Activities or areas of cost that require examination 506. These so-called significant Activities are typically those which the DFTA Team-using experience or a priori knowledge-deem to have either non-trivial cost (eg. >$1,000 by company policy), or to be critical in nature (eg. a safety check). Thus significant Activities for the Cost Objects under examination are cataloged 507 in a worksheet called an EABEM catalog. Next, a process of Activity Probing 508 (Sub-process I) is performed to identify how much data collection and modeling will be required. The EABEM catalog is again used here, along with enterprise documents or worksheets identifying process flows, and external Resources.

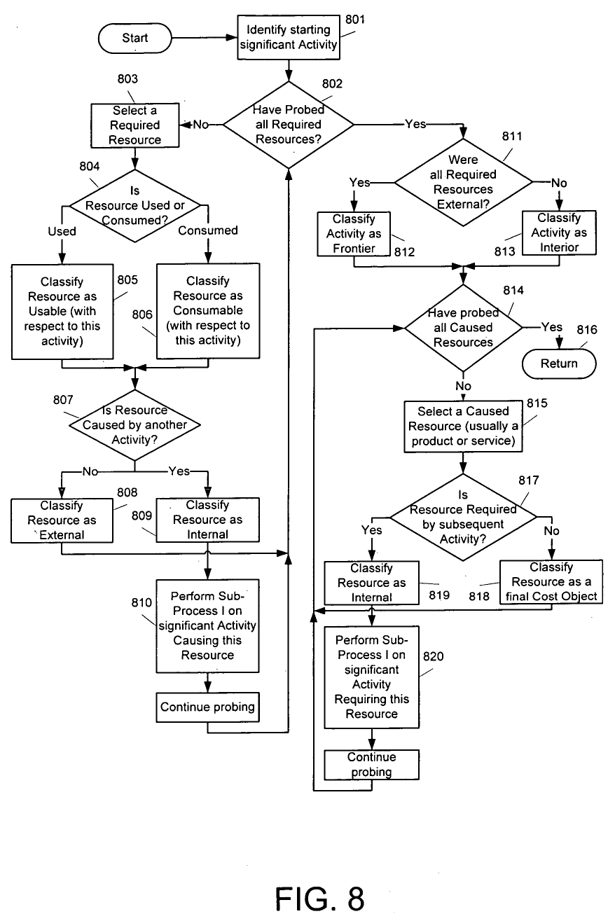

Sub-process I is shown in FIG. 8 and consists of the following steps.
1) First a starting Activity is chosen 801 from the catalog of significant Activities. An example of a significant Activity may be “Assemble Pallet” in the warehousing example. The flexibility of this sub-process permits the starting with any Activity, not just the Cost Object.
2) It is determined if all of the Resources Required by this Activity have been probed 802. If so skip to Step 6, otherwise proceed to Step 3.
3) An unprobed Required Resource is selected 803 for classification.
4) Now the type of the Resource is checked 804 and if it is used, the Resource is classified as Usable 805 by the current Activity and if it is consumed, the Resource is classified as Consumable 806.
5) Another categorization is now performed 807 to see if the Resource should be classified as External 808 or Internal 809. An example of an External Resource for the “Assemble Pallet” Activity could be “pallet”, “plastic wrap”, or “forklift”. An example of an Internal Resource could be a “labeled case”. If the Resource was External, return to Step 2, and in the case where the Resource was Internal, Sub-process I is performed on the Activity which Caused this Resource 810. Once this probing has completed, flow is returned and classification of the next Resource in this cluster is done by returning to Step 2.
6) Once all of the Required Resources have been modeled, the Activity itself can be classified 811. If all of the Required Resources were External then the Activity is considered a Frontier Activity 812, and if this was not the case, the Activity is considered Interior 813.
7) Now as long as there are more Caused Resources to probe 814, a Caused Resource is selected 815, otherwise flow returns 816 to the calling process.
8) If it is not required by a subsequent Activity 817, it is classified as a Cost Object 818, otherwise it is classified as an Internal Resource 819 at which point Sub-process I is performed on the Activity Requiring this Resource 820. After flow is returned from this Sub-process I, probing continues on any remaining Resources at Step 7.

With steps 501-508 shown in FIG. 5A complete, it should be relatively clear what data will be necessary from the operational data sources, after which the manner of obtaining this data 509 should be determined, as well as how it will be accessed 510. Before proceeding into modeling, it is important to test and validate 511 the assumptions and decisions made to ensure that the correct business needs will be met with the plan in place.

The Profit Information System 601 is the aspect of the computer system that would handle the accessing of relevant cost data during the Preparation phase. The operational data source will generally consist of one or more sources of operational data for the organization 602-606. The PIS 601 enables the extraction, translation, and loading of data from operational data sources, which in the value-added warehousing example might be a Warehouse Management System (WMS) 602, Order Management System (OMS) 603, Accounting System 604, a CRM System 605, or an ERP System 606.

In this example, extraction may involve interfacing and retrieving data from a database, and translation could be the parsing and converting of units of measure into desired formats, the fixing of inconsistent Activity names, and the addition of keys to facilitate the searching and querying of the data by the computer system in later phases of the method. Loading would generally consist of the process of passing the data on to the Profit Knowledge System PKS 609, wherein the cost data will be turned into cost information, as described later. The PIS 601 would also be responsible for the persistence of data for the computer system. This data would most frequently be stored after processing by the PKS 609 or Profit Decision System (PDS), but could also come over directly from an operational data source or the Internet via the PIS.

In this example, the operational data sources 602-606 would contribute different types of data. A Warehouse Management System (WMS) 602, for example, can generally be used to retrieve information about activities performed while handling a product, the times that the activities were performed, and information about the product being handled. As such, the WMS would generally be the main source of data that is used to populate the Activity and State entities in the EABEM model described later, and also to provide general attribute data about products being handled in the warehouse. Some of this data could also come from an Enterprise Resource Planning (ERP) 606, system, such as SAP or PeopleSoft. The data for Resource entities, which are also described later, would frequently come from an Accounting System 604 which might be either a stand-alone package such as those from AccPac or Peachtree, or as a module of an ERP system. The Order Management System 603 and Customer Relationship Management (CRM) system 605, such as one from Siebel Systems, generally contain information about customers and customer orders, and as such are an important source of data for the Utilization Facilities of the invention, which are described later.

Model Development (Section III)

By exiting the Preparation phase, it should now be clear what cost information is desired, where it will come from, how to get it, and for what purposes this information will be used. In the Modeling phase, represented in FIG. 5B, this information is captured in an ontological knowledge representation, called an EABEM, using the computer system of the present invention.

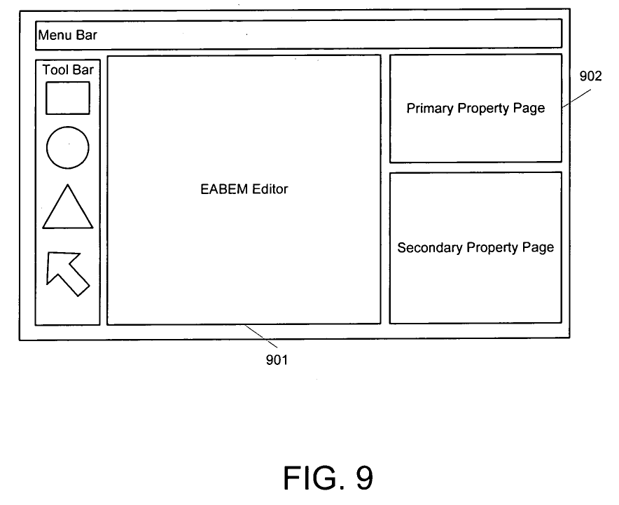

The EABEM is created in the modeling facility of the PKS 609 aspect of the computer system. The modeling facility includes a known graphical user interface (GUI) that enables one or more users to model an enterprise in accordance with the methodology described herein. FIG. 9 shows a possible layout for the GUI of the modeling facility, which is also fundamentally the design of the GUI for other facilities of the computer system and computer program. The modeling facility is integral to this invention because it provides a visual aid for the creation and management of the ontological model, whereas the costing facility, described later, uses this EABEM model to yield costs using the concepts of Temporal-ABC.

Improvements on Prior-Art

Some important improvements were made to the thesis of Dr. Tham to improve usability and understandability of the models for those not as familiar with the modeling paradigms upon which it was originally developed. This consideration is important to the commercial use of the EABEM and Temporal-ABC concepts as users will generally be less familiar with these principles.

The changes include the following:

1) Modified Nomenclature
Internal Activity to Interior Activity
The EABEM ontology presented in Dr. Tham's thesis referred to above refers to Frontier Activities and their counterpart Internal Activities. To avoid confusion with the terms External and Internal used in the ontology to describe Resources, the term Interior Activity was introduced to replace the term Internal Activity as it was a more descriptive opposite to Frontier Activities.
Enables Relationship to Requires Relationship
The EABEM ontology as laid out in Dr. Tham's thesis for modeling an enterprise uses a concept of an “Enables” Specification. It was found that this nomenclature would prove confusing to new users of the ontology. This is because the original enables relationship suggested a directional relationship not in keeping with the directional relationships in the rest of the ontological relationships. In order to correct this inconsistency, the relationship has been renamed “Requires”.
Non-Terminal State Block to State Junction
The thesis of Dr. Tham described both “Terminal” and “Non-Terminal State Blocks”, which although ontologically descriptive, provided little information to the users as to what each type of State Block actually did. It was much more understandable and descriptive to call what is referred to in the thesis as “Non-Terminal State Blocks” as “State Junctions”.
Terminal State Blocks to State Blocks
With the absence of any other form of State Block, it made the most sense to call the former “Terminal State Blocks” simply “State Blocks”.

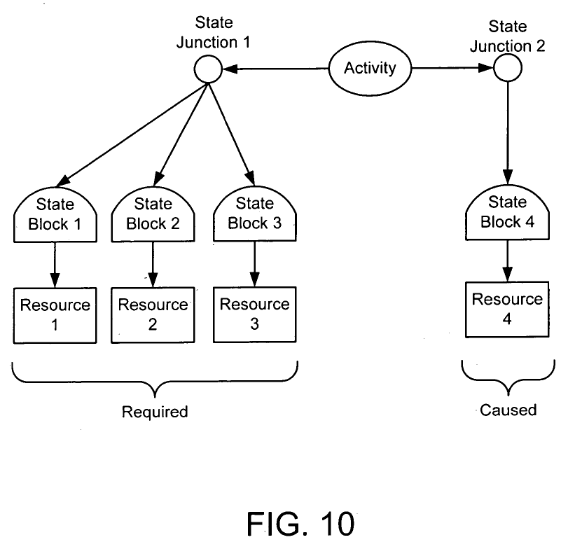

2) Visual Representation of Entities
The shapes used in figures to visually represent the various TOVE entities were changed to be more understandable and usable for the purposes of the modeling facility of the computer system. The visual representation of the EABEM is an aspect of the proposition of the present invention. The new Glyph shapes are shown in FIG. 10.
   Background Concepts

In Dr. Tham's methodology, subject to the clarifying changes just described, an EABEM model is composed of the following four entities: Resources, State Blocks, State Junctions, and Activities. Naturally, the modeling facility of the invention must allow for visualization of these entities in the computer system. FIG. 10 shows an example of how these entities might typically appear in the modeling facility of the present invention.

In order to create an EABEM, several data quantities or properties are preferred. They are:
ccRate: The rate used to quantify the opportunity cost associated with capital that could otherwise have been invested in another project or interest bearing financial instrument.
rRate: The rate used to quantify the opportunity cost associated with lost productivity, and hence, revenue production, due to inefficiencies in operations.
Total cost: The total cost in a chosen currency of all units of a Resource.
Quantity: The total number of units of a Resource.
Manner of requirement or causality by an Activity: If the Resource is being Used, Consumed, or Produced by an Activity
Data Type: specifies if a Resource is required or caused in a discrete or continuous manner
The State with respect to an Activity: A State is a particular sequence of Statuses over time with respect to an Activity. The possible Statuses are Committed, Enabled, Disabled, and Re-enabled. The Committed Status is used to describe a period when the Resource is allocated to a particular Activity, but is not actually being used for its purpose yet. The Enabled Status refers to the period in which a Resource is being used for its purpose. The Disabled Status refers to the period when a Resource fails to perform its intended purpose (e.g. when it gets broken). The Re-enabled Status refers to the period in which a Resource returns back from a Disabled Status to performing its intended purpose.
The Specification (Spec): Defines the manner in which an Activity uses, consumes, or produces a Resource, either at a rate or as discretely defined units.
Activity Relationship: either Requires or Causes depending on the relationship between the State Junction and Activity
Junction type: either conjunctive or disjunctive for State Junctions depending on whether or not the State Blocks associated are related in an Boolean AND or XOR manner, respectively

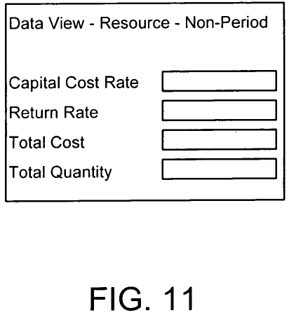

The Resource entity represents something that is either Required (used or consumed) or Caused (i.e. produced) by an Activity. It can be a machine, a worker, floor space, depreciation on a building or anything else that can have a cost associated with it. Resources are referred to as either Internal if they are caused by an Activity in the EABEM, or External if they are not produced within the EABEM, but instead come from external sources. One of the primary differences between the classes of Resources lies in how they related to Activities. While multiple Activities can consume the same Resource, multiple Activities cannot concurrently use the same Resource. Furthermore, only one Activity may produce a particular Resource. There are two types of Resources, Period and Non-Period Resources. Non-Period Resources are Resources whose costs are entirely dependent on usage (e.g. hydro, water, indirect materials). FIG. 11 illustrates a possible interface for receiving the data for a Non-Period Resource. The data properties for a Non-Period Resource are:
ccRate
rRate
Total cost
Quantity

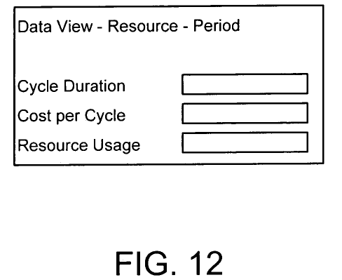

While the Total Cost and Quantity values are entered directly for Non-Period Resources, they are derived for Period Resources. Period Resources (e.g. property taxes, leases, wages) are Resources which cost a fixed amount of money over a specified period of time. For example in a lease of $1000 paid on a yearly cycle, the $1000 is known as the Cost per Cycle, the year is known as the Cycle Duration, and the $1000/year is referred to as the Cycle Cost. Thus for Period Resources, the Quantity is actually a measure of usage over time, and is therefore referred to as the Resource Usage. Accordingly, the Total Cost for a Period Resource is actually obtained by prorating the Cost per Cycle over the Resource Usage. As a further difference, explained in detail later, the ccRate and rRate are also not necessary for the costing of Period Resources. FIG. 12 illustrates a possible interface for receiving the data for a Period Resource. The data properties for a Period Resource are:
Cycle Duration
Cost per Cycle
Resource Usage

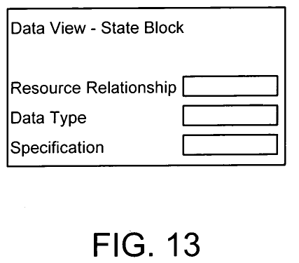

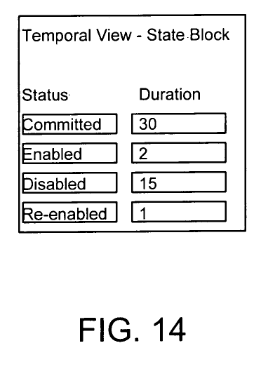

The Requires State Block embodies all the information with respect to how an Activity is making use of a particular Resource over time. FIG. 13 shows a possible interface for setting the specification of a Requires State Block, and FIG. 14 shows a possible interface for setting the State for the State Block. Each Activity that uses a Resource must have a Requires State Block connected to the Resource. A Requires State Block is connected to an Activity via a State Junction. The data properties for a Requires State Block are:
Manner of requirement by an Activity (if the Resource is being Used or Consumed by an Activity)
Data Type (if the related Resource is Used or Consumed discretely- or continuously)
The State with respect to an Activity
The Specification (Spec) that quantifies how much of the Resource is being used by an Activity and how it is being used (continuously or discretely)

The Causes State Block embodies all the information with respect to how an Activity produces a Resource. A Resource may be produced by only one Activity, as dictated by the axioms and ontology of Dr. Tham's thesis. For example, a Resource, such as “labeled product” can be produced only by one Activity, say “label product”. Having more than one Activity produce the same Resource would violate the unambiguous ontological design of Temporal-ABC. The Causes State Block connects to every produced Resource, and connects to every Activity via a State Junction. The data properties for a Causes State Block are:
Manner of causality by an Activity (If the Resource is being Produced by an Activity)
Data Type (if the related Resource is Produced discretely or continuously)
The Spec that quantifies how much of the Resource is being produced and how it is being produced (continuously or discretely)

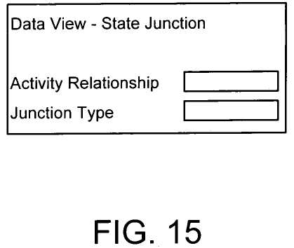

Requires State Junctions aggregate several Requires State Blocks or other Requires State Junctions. FIG. 15 shows a possible interface for setting the properties of a State Junction. Each Activity is connected to one Requires State Junction. Requires State Junctions can either be in a conjunctive state (Conjuncts) or a disjunctive state (Disjuncts). The conjunctive state mandates that all the aggregated entities of a Requires State Junctions must be concurrently required. The disjunctive state mandates that one and only one of the aggregated entities can be used at any given time. Refer to the aspect of this invention that concerns Validation for further details. The data properties for a State Junction are:
Activity Relationship (Requires or Causes)
Junction Type

Causes State Junctions aggregate several Causes State Blocks. Each Activity is connected to one Causes State Junction. FIG. 15 shows a possible interface for setting the properties of a State Junction. Causes State Junctions can only be in a conjunctive state. In this context, the conjunctive state implies that all aggregates entities are concurrently caused.

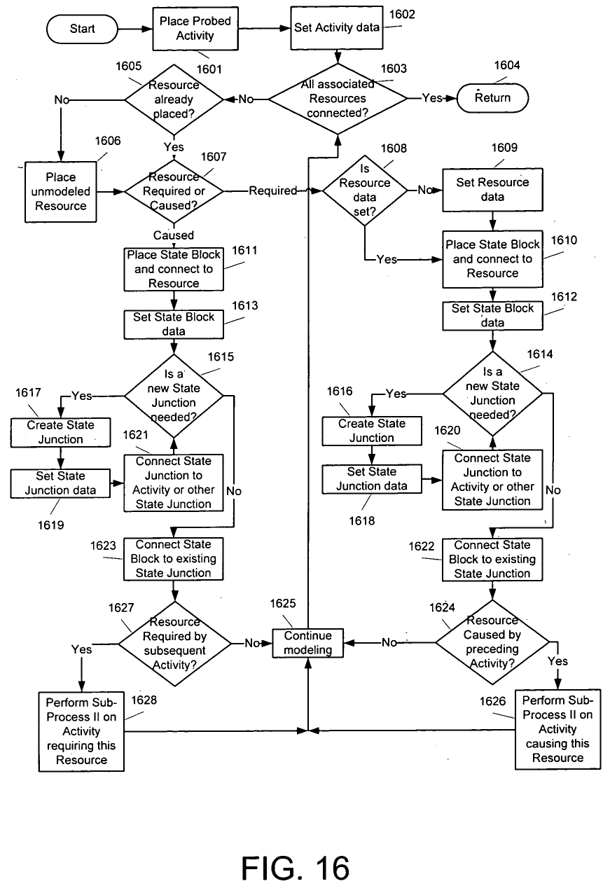

Now having gone over the EABEM concepts as they are used in the present invention, the description of the Modeling phase will be understandable. The first step in the Modeling phase of the method shown in FIG. 5B is to construct the EABEM using the computer system 512 based upon the results of the Preparation phase. This construction process in the modeling facility of the present invention is not obvious and is illustrated by Sub-process II in FIG. 16. The standard steps of Sub-process II are as follows, and do not include the expediting advantages of auto-morphing and auto-generation which are described later.
1) A probed Activity from the catalog is added to the EABEM 1601. This will be referred to as the current Activity.
2) The data properties of the current Activity as specified above are set 1602.
3) If all the Resources found by the probing are connected 1603 then return from the sub-process 1604, otherwise proceed to Step 4.
4) If the Resource was placed in the EABEM already 1605, skip to Step 6, otherwise proceed to Step 5.
5) Place the Resource 1606.
6) Identify if the Resource is Required by the current Activity or Caused 1607. If the Resource is Required then go to Step 7, otherwise skip to Step 8.
7) Evaluate if the Resource data has been set yet 1608. If it has, skip to Step 9, otherwise continue at Step 8.
8) Set the Resource data properties using the modeling facility 1609.
9) Place a State Block to associate with the Resource 1610, 1611.
10) Set the data properties for the State Block 1612, 1613. In the warehousing example a Uses State Block would be connected to a “forklift” Resource, and a Consumes State Block would be connected to the “fuel” Resource.
11) If a new State Junction is needed 1614, 1615, go to Step 12, otherwise skip to Step 15.
12) Create a new State Junction 1616, 1617.
13) Set the data properties of the State Junction 1618, 1619.
14) Connect the State Junction to the current Activity, or to other State Junctions as needed 1620, 1621. Return to Step 11.
15) Connect the State Block to the appropriate State Junction 1622, 1623.
16) When the current Resource is Required, evaluate the causality of the Resource 1624. If it is not Caused by a preceding Activity, then continue modeling the next Resource 1625, otherwise repeat this sub-process II starting at Step 1 for the Causing Activity 1626. When the current Resource is Caused, evaluate the requirement of the Resource 1627. If it is not Required by a subsequent Activity, then continue modeling the next Resource 1625, otherwise repeat this sub-process II process starting at Step 1 for the Requiring Activity 1628.

After sub-process II is completed, the fundamental EABEM has been built. However before it can be used to generate costs using Temporal-ABC, temporal data population 513 must be performed. In a forensic cost analysis, Resource States are generally determined first, from which Activity States are then derived. Resource States are determined by temporal data population, which involves specifying the time periods that the State Block has a particular Resource Status (i.e. Committed, Enabled, Disabled, Re-enabled as defined above). This is called a temporal profile, and is often supported in a manual use case by enterprise documentation and worksheets such as downtime reports and employee logs. As an example, if a State Block has a lifespan of 3 hours and 45 minutes, the user will need to specify the Statuses of the State Block over this time. For instance, a temporal profile may consist of 30 minutes committed, followed by 2 hours enabled, 15 minutes disabled, and 1 hour being re-enabled. After temporal data has been loaded the temporal data population is described in Sub-process III, shown in FIG. 17.

The steps for sub-process III are as follows:
1) A time period of study is chosen for the EABEM 1701. When this sub-process is for a forensic study, the DFTA Team will generally determine this period of study.
2) The granularity of the study is chosen by selecting the smallest unit of time that will be measured, for example seconds or hours 1702.
3) An Activity cluster that has not yet gone through the temporal data population process is selected from the EABEM 1703.
4) The first unit of time to examine is chosen 1704.
5) Determine if all State Blocks in the cluster have a Status 1705 for its Resource over this time unit. If they have, proceed with Step 15, otherwise move to Step 6.
6) Choose a Required State Block that does not have a Status for its associated Resource over the current time unit 1706.
7) Determine the Status of the Resource associated with this State Block over the current time unit 1707. The possible Statuses are Unused, Committed, Enabled, or Disabled.
8) Now ensure that the Status was successfully determined 1708. If it was not then go on to Step 13, otherwise continue with Step 9.
9) Determine how long the Resource has this Status 1709.
10) Perform a Validation check, as described later 1710.
11) If the State Block passes the Validation check 1711, then proceed to Step 12, otherwise skip to Step 13.
12) Populate the Status of the State Block for the entire duration determined 1712. Continue at Step 5.
13) Since the Status cannot be determined either because of a validity error or another possibly unknown reason, record the error and produce a notification either via the computer system of the present invention or directly to a person 1713.
14) Decide whether to take a corrective measure to fix the error (often by providing a temporary “best-estimate”) and continue, or to stop the process until the error has been resolved 1714. If correcting and continuing, reattempt Step 8, otherwise Return from the sub-process 1715.
15) Determine if there are still time units in the period of study for which temporal data population has not been attempted 1716. If there are more time units to examine continue at Step 16, otherwise skip to Step 17.
16) Select the next time unit to model 1717. Proceed to Step 5.
17) Identify if there are any more Activity clusters in the EABEM that have not gone through this temporal data population process for the period of study 1718. If there are, go to Step 3, otherwise return from this sub-process 1715.

With the temporal data population complete, Activity States can now be derived automatically by the computer system from the States of their Required Resources.

The Statuses of Resource States are combined differently dependent on whether the Resources are conjunctively or disjunctively required. At each State Junction, Resource Statuses are combined according to the tables below to produce Aggregate Resource Statuses (ARS) for the State Junction. The ARSs from multiple State Junctions are further aggregated until the Activity is reached, at which point the final ARS are converted to Activity Statuses to give the Activity's State.

Note that an Activity State can only be automatically determined for Activity clusters that pass temporal validity rules, as described later. TABLES 1-3 show the transitions from Resource Statuses to Aggregate Resource Statuses and then the Aggregate Resource Statuses to Activity Statuses.

TABLE 1

| Valid Resource Status | Resulting Aggregate |
|---|---|
| Conjunctive combination | Resource Status |
| All Unused | Unused |
| All Committed | Committed |
| All Enabled | Enabled |
| All Disabled | Disabled |
| All Re-enabled | Re-enabled |
| Unused and Committed | Committed |
| Committed and Disabled | Disabled |
| Enabled and Re-enabled | Enabled |
| Disabled and Unused | Disabled |

TABLE 2

| Valid Resource Status | Resulting Aggregate |
|---|---|
| disjunctive combination | Resource Status |
| All Unused | Unused |
| All Committed | Committed |
| All Disabled | Disabled |
| Unused and Committed | Committed |
| Committed and Disabled | Disabled |
| Unused and Disabled | Disabled |
| One Enabled, others | Enabled |
| Committed, Unused | |
| or Disabled | |
| One Re-enabled, others | Re-enabled |
| Committed, Unused or | |
| Disabled | |

TABLE 3

| Valid Resource Status | |
|---|---|
| or Aggregate Resource | Resulting |
| Status | Activity Status |
| Unused | Completed |
| Committed | Dormant |
| Enabled | Executing |
| Disabled | Suspended |
| Re-enabled | Re-executing |

With the EABEM constructed and Resource and Activity Statuses now determined, the costing facility of the computer system, described later, is used to perform a forensic or historical cost analysis 514. This forensic analysis involves querying historical data to determine the cost of operations that have already occurred. Cost queries to the forensic model occur as follows in one particular aspect of the invention.

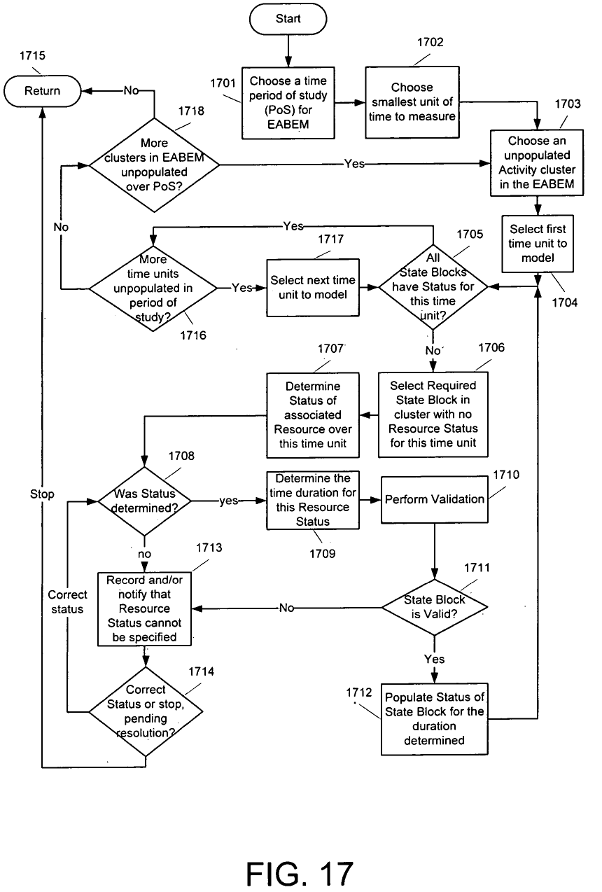

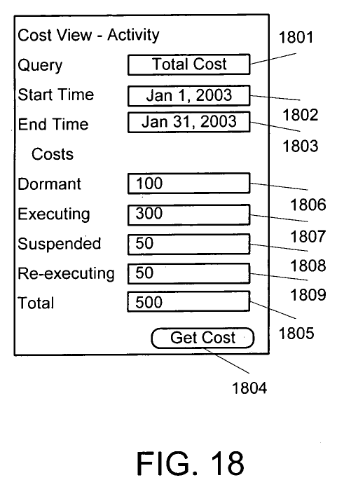

A more detailed description of the costing facility of the computer system is provided later, but briefly, a cost query occurs by means of “forward-chaining” algorithms on the knowledge representation (as defined in Artificial Intelligence circles) that is the EABEM and Temporal-ABC data. This enables the costing facility of the present invention to capitalize on the fact that cost information obtained from a first Activity may be subsequently used in a second Activity, third Activity, and so on. Therefore, an Activity is costed using the following procedure:
1) The user clicks on the Activity icon in the EABEM Editor 901 (FIG. 9) for which s/he would like to obtain the cost.
2) In a “Cost View” such as that shown in FIG. 18, the user picks the type of cost query s/he wishes to perform 1801 (e.g. “Total Cost”). Views such as the cost view would appear in a property page 902 in the GUI.
3) The user specifies the period over which the query is to be performed by entering a start time 1802 and end time 1803.
4) The user instructs the costing facility to execute the query 1804. The final cost 1805, and the costs broken down by Status 1806-1809 are displayed in the “Cost View”.

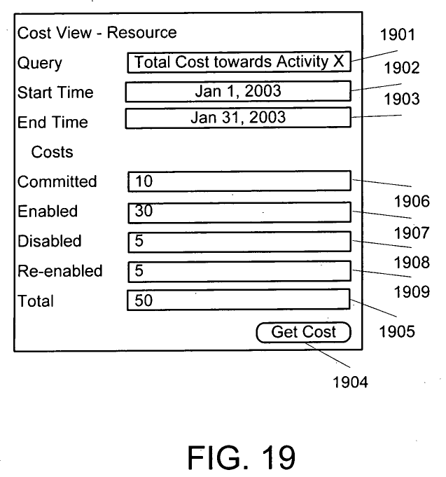

A Resource is costed using this procedure:
1) The user clicks on the Resource icon in the EABEM Editor 901 (FIG. 9) for which s/he would like to obtain the cost.
2) Since Resources may be connected to more than one Activity, in the “Cost View” such as that shown in FIG. 19, the user must pick for which Activity it should be costed 1901.
3) The user specifies the period over which the query is to be performed by entering a start time 1902 and end time 1903.
4) The user instructs the costing facility to execute the query 1904. The final cost 1905, and the costs broken down by Status 1906-1909 are displayed in the “Cost View”.

As shown, the forensic analysis can be used to identify the cost of interest for Resources, Activities and particular times. This is a valuable exercise to identify best-practices, problem areas, and general opportunities for continuous improvement. This also creates a baseline cost model of the modeled enterprise processes, which can be tested and validated 515 by the DFTA team to ensure that the model has been constructed properly. It can then be reviewed 516 by the DFTA team to ensure that the correct CQs, CIMs, and business objectives are being addressed, as the final stage of the Modeling phase before entering the Costing Phase. This baseline cost model will serve as a reference point for future cost analyses.

There are two other particular aspects of the invention which apply to the Modeling Phase of the present invention. One of the major challenges with creating an EABEM for a real-world enterprise is managing the creation of the EABEM in the first place. The more useful the EABEM, the larger it must be. Another aspect of the present invention is a novel way to increase the speed with which a model can be created. Two techniques were invented to this end, one called auto-morphing, and the other auto-generation.

In order to properly understand how these techniques work, a brief background is required. The EABEM ontology consists of a hierarchy of Activities, Resources, State Blocks, and State Junctions. The interactions between different entities in the hierarchy are facilitated via connections. Generally speaking, there are four connection classes (CC):
CC1: Activity-State Junction attachment
CC2: State Junction-State Junction attachment
CC3: State Junction-State Block attachment
CC4: State Block-Resource attachment

Entities can only be connected within each connection class (CC). Each connection class has certain rules and dependencies that dictate the manner in which valid relationships can be formed. In the modeling facility of the present invention, these connection rules and dependencies are abstracted from the end user through entity auto-morphing, entity auto-generation, and intuitive feedback mechanisms (e.g. visual rejection of non-CC connections),

Auto-Morphing

Entity auto-morphing is a new mechanism that automatically enforces connection dependencies each time any changes are made to EABEM entities that support morphing. It fundamentally enhances the usability of the modeling facility in two ways:

a) Consistency:

Connection dependencies are automatically validated and corrected every time a change is made to a particular connection, ensuring that the model will structurally conform to the EABEM ontology.

b) Speed:

Automatically propagating dependency changes relieves the modeler of maintaining structural consistency such that she can easily and quickly manipulate the structure of the EABEM.

Currently, auto-morphing is used extensively for CC2 and CC4 connections and behaves differently in each context.

CC4: State Block-Resource Attachment

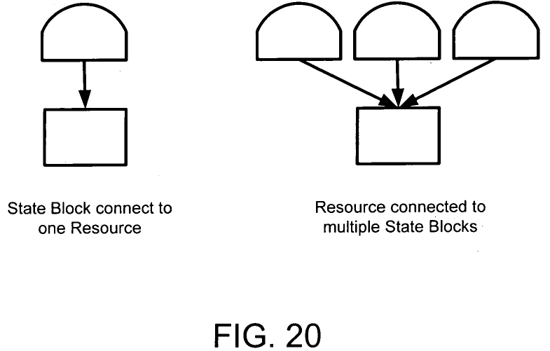

This connection type supports a variety of different auto-morph capabilities. Although a State Block can only connect to one Resource, a Resource can be connected to many different State Blocks as indicated in FIG. 20.

There are 4 different types of State Blocks: Anonymous, Consumer, User, and Producer. Anonymous represents the initial type of State Block when it is created in the modeling facility. Consumer, User, and Producer are user-selectable types. Essentially, auto-morphing in CC4 connections is triggered when a State Block's type changes.

There are 7 types of auto-morphing, all of which affect the Resource involved in the CC4 connection. Depending on the change, the Resource's Usage and/or Origin attribute will be modified by an auto-morph.

M1: Anonymous to Consumer/User

In an M1 morph, an Anonymous State Block connected to a Resource is changed to either a Consumer or User. Accordingly, the Resource Usage attribute will morph to a Consumable or Usable. If the Resource is Consumable, subsequently connected State Blocks must be Consumers. Similarly, if the Resource is Usable, subsequently connected State Blocks must be Users.

M2: Anonymous to Producer

In an M2 morph, an Anonymous State Block connected to a Resource is changed to a Producer. The Resource Origin attribute will morph to Internal to indicate that the Resource is now produced internally by the EABEM.

M3: Consumer to User

In an M3 morph, a Consumer State Block connected to a Resource is changed to a User. If the modified State Block is the only Requires State Block connected to the Resource, the Resource Usage attribute is changed to Usable. If there are other Consumer State Blocks connected to the Resource, the Resource will remain Consumable and the newly modified User State Block will be automatically disconnected from the Resource.

M4: User to Consumer

In an M4 morph, a User State Block connected to a Resource is changed to a Consumer. If the modified State Block is the only Requires State Block connected to the Resource, the Resource Usage attribute is changed to Consumable. If there are other User State Blocks connected to the Resource, the Resource will remain Usable and the newly modified Consumer State Block will be automatically disconnected from the Resource.

M5: Consumer/User to Producer

In an M5 morph, a Consumer or User State Block connected to a Resource is changed to a Producer. The Resource Origin attribute will morph to Internal to indicate that the Resource is now produced internally by the EABEM. If there is already a Producer connected to that Resource, than the newly modified Producer is disconnected.

M6: Producer to Consumer

In an M6 morph, a Producer connected to a Resource is changed to a Consumer. The Resource Origin attribute will morph from Internal to External to indicate that the Resource is now an externally produced Resource. If there are no other State Blocks connected to the Resource, the Resource Usage attribute will morph to Consumable. If there are other Consumers already attached to the Resource, the Resource will remain Consumable. If there are other Users already attached to the Resource, the Resource will remain Usable and the new Consumer will be disconnected from the Resource.

M7: Producer to User

In an M7 morph, a Producer connected to a Resource is changed to a User. The Resource Origin attribute will morph from Internal to External to indicate that the Resource is now an externally produced Resource. If there are no other State Blocks connected to the Resource, the Resource Usage attribute will morph to Usable. If there are other Users already attached to the Resource, the Resource will remain Usable. If there are other Consumers already attached to the Resource, the Resource will remain Consumable and the new User will be disconnected from the Resource.

In general, note that auto-morphing via a CC4 modification only impacts the connected Resource and/or the modified State Block. All other State Blocks are left untouched.

CC2: State Junction-State Junction Attachment

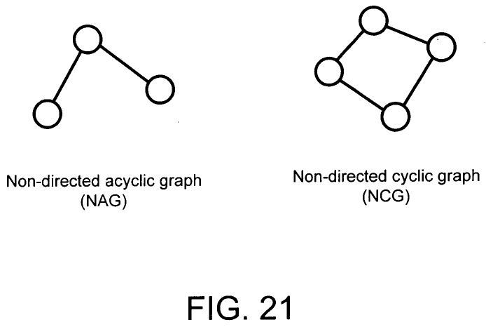

FIG. 21 illustrates the various ways that State Junctions can be initially attached to other State Junctions. Note that this figure shows connected State Junctions without the context of an Activity

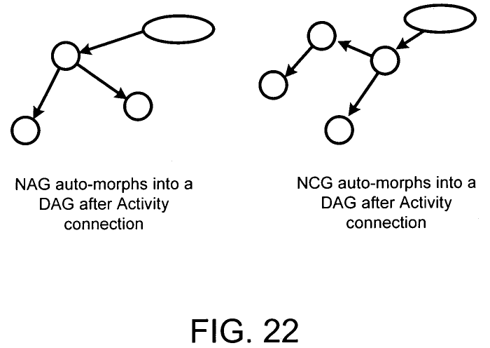

FIG. 22 shows how CC2 auto-morphing allows for the automatic conversion of both State Junction non-directed acyclc graphs (NAGs) and non-directed cyclic graphs (NCGs) into directed acyclic graphs (DAGs) once a NAG/NCG connects to an Activity.

Further, as more State Junctions are added to a State Junction DAG, the orientation of the arrows and connection labels (which respectively indicate the hierarchy and the Requires/Causes relationship) will be automatically assigned.

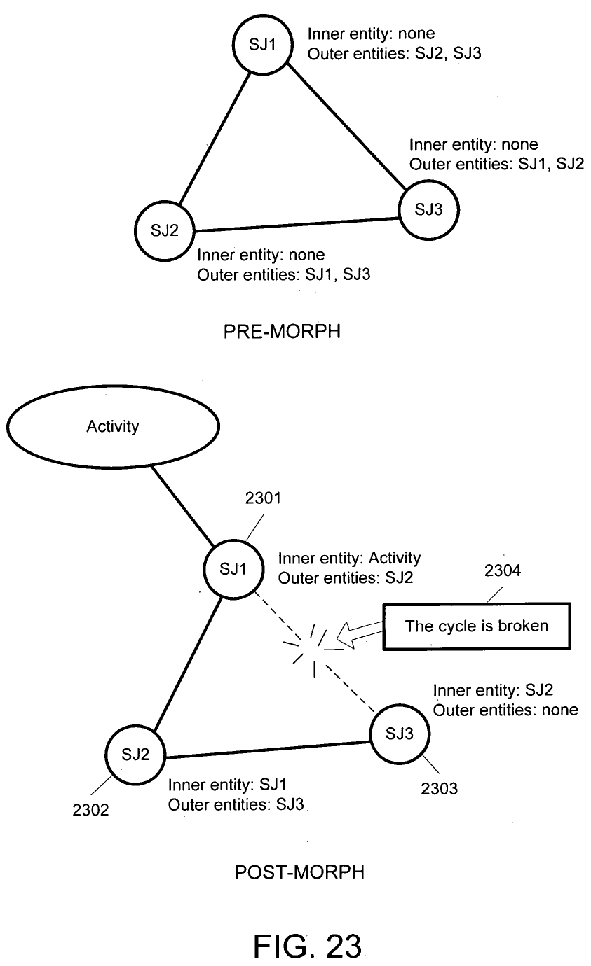

FIG. 23 illustrates an NCG to DAG morph upon connection of an Activity. The pre-morph state features three State Junctions connected in an NCG. Each State Junction has the concept of an Inner Entity (IE) and one or many Outer Entities (OE). Prior to the morph, the State Junctions do not have IEs and all connected entities are OEs. Once the Activity is connected to SJ1, SJ1 is set as the current OE and Activity is set as the current IE. The auto-morph algorithm then proceeds recursively as follows:

Step 1a: If the Current OE has no Inner Entity:

i) The current IE is set as the current OE's Inner Entity.
ii) The current IE is removed from the current OE's list of Outer Entities (if it was ever in the list).
iii) Proceed to Step 2.
   Step 1b: If the Current OE has an Inner Entity:
i) The current OE is disconnected from the current IE.
ii) Proceed to Step 2.
   Step 2: For each Child Entity Left in the Current OE's List of Outer Entities,
i) Set current IE=current OE.
ii) Set current OE=child entity.
iii) Proceed to Step 1a.

Thus, in FIG. 23, the NCG is morphed to a DAG as follows:
1) SJ1 sets its Inner Entity to the Activity 2301
2) SJ2 sets its Inner Entity to SJ1 and removes SJ1 as an Outer Entity 2302
3) SJ3 sets its Inner Entity to SJ2 and removes SJ2 as an Outer Entity 2303
4) SJ1 attempts to set its Inner Entity to SJ3 but SJ1 already has an Inner Entity (Activity) so SJ1 is disconnected from SJ3 2304, which removes SJ3 from SJ1's list of outer entities

Clearly with the modeling facility of the computer system automating this procedure, much of the user work is removed.

State Entity Auto-Generation

State entities are critical to the T-ABC paradigm as they both encode the time-varying behavior of the EABEM and allow Activities and Resources to be interconnected. However, the structural development of an EABEM typically proceeds with Activity and Resource probing, followed by an initial layout consisting of only the significant Activities and Resources. This procedure allows for greater speed, clarity, and simplicity in modeling. Not only does the UI not become cluttered with State entities, but the simplification permits even those not familiar with EABEM concepts to develop the basis of the EABEM model. The new concept of auto-generation is then needed to help complete the model by automatically creating State Blocks and State Junctions (collectively called State entities) in the EABEM after Activities and Resources have been placed using the modeling facility. This enhances the usability of the modeling facility in two main ways:

a) Convenience

The crux of the modeling process is the determination of the significant Activities and Resources and, as such, these entities would typically be the first nodes created in an EABEM. As the number of Activities and Resources grows, the critical task of adding State entities to this model is tedious but is simplified by the auto-generation function.

b) Speed

The automatic generation and placement of States entities significantly reduces the number of glyphs that is created by the end user which allows for rapid EABEM development.

c) Visualization of Activity Clusters

Since auto-generation will position State entities relative to Activities and Resources in a consistent manner, it helps to promote a standardized look and feel of EABEM, making it a superior visualization for communication purposes.

Currently, auto-generation is used for CC1 and CC4 type connections.

Auto-Generation for CC1 Connections

In this scenario, the auto-generation function will first detect either Activities that are currently not connected to Requires and/or Causes State Junctions or Activities for which auto-generation was not previously performed. For each Activity, Requires State Junctions are added to the left of the Activity while Causes State Junctions are added to the right of the Activity as needed.

Auto-Generation for CC4 Connections

In this scenario, the auto-generation function will first detect either Resources that are currently not connected to State Blocks or Resources for which auto-generation was not previously performed. For each Resource, a State Block is added above the Resource.

Referring back to the modeling sub-process shown in FIG. 16 it can be seen that a significant number of entity and connection placements do not have to be performed manually if the modeling facility of the computer system does it automatically. The novel auto-morphing and auto-generation techniques described clearly make the modeling process using the computer system much more efficient.

Through this description of the modeling phase of the method, the complexities of building an EABEM should be evident, and the need of the method and computer system of the present invention for efficient and accurate modeling for Temporal-ABC should be apparent.

Cost Generation (Section IV)

The Costing Phase of the method, shown in FIG. 5C, is where the Temporal-ABC rules and calculations are applied to the model created and populated with data in the preceding Modeling Phase. With the EABEM verified, it must now be modified in the computer system in preparation for continuous operational use for costing in real-time. Since this will be an ongoing process, the first step preferred in the Costing Phase is training 517 any users of the computer system. The training would typically involve the teaching of EABEM and Temporal-ABC concepts, as well as how to use and manage the computer system itself, and would usually be conducted by the Process Facilitator or Product Manager, as the individuals most familiar with both matters. Next the DFTA team will ensure that the computer system is configured for operational use 518. This typically involves ensuring that the computer system is set up to interact appropriately with other operational systems, in the manners decided in the Preparation Phase. Next the EABEM is prepared for real-time usage 519. This preparation involves the specification of particular properties in the EABEM which are needed for it to cost operational data in real-time or for subsequent utilization of the cost information by other facilities of the computer system, such as the billing facility. A description of what occurs in this step will be described later. The next step is where the computer system functions as an operational system itself, automatically interfacing with operational data systems to perform temporal data population and costing 520. It is here in the costing facility of the present invention, part of the Profit Knowledge System 609 shown in FIG. 6, that the value of the computer system is realized the most. A more detailed description of temporal data population and costing in real-time is provided later.

Background on how Temporal-ABC costs are derived by the costing facility will be useful.

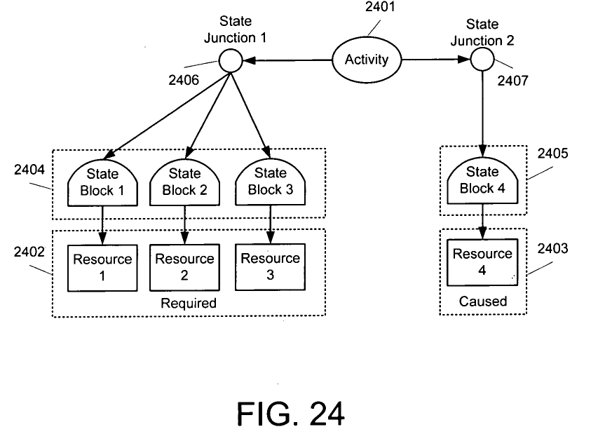

The costing facility integrates with the modeling facility in order to output Temporal-ABC results, such as costs and cost metrics, from an EABEM. In an EABEM, Activities will typically require Resources that are produced by other Activities. The purpose of the costing facility is to determine the cost of a Cost Object or end product by aggregating the costs of Activities and Resources Required to bring this cost object into existence. The manner by which this is done is described generally by the Activity cluster shown in FIG. 24 and the text that follows, which builds upon the background provided for modeling earlier.

The cost of an Activity 2401 represents the aggregation of all the costs of the Resources that are Required by the Activity 2402. Further, the purpose of an Activity is to produce or generally cause some Resource(s) 2403 to be available to the enterprise. Thus, the cost of a produced (caused) Resource is determined from the following quantities:
The total cost of performing the producing Activity
The State of the producing Activity
The Spec that quantifies how much of the Resource is being produced; and
The number of these Resources outputted by the producing Activity

Requires State Blocks 2404 generate the cost of a Resource with respect to an Activity. This is done using methods set out in Dr. Tham's thesis using the information contained in the Resource and the State Block in question, and is summarized in TABLES 4 and 5.

TABLE 4
Continuous

| | |
|---|---|
| Committed Status cost | =u_{c}*spec*Δt*ccRate*Δt |
| New unit cost after | =u_{c}*(1 + ccRate* Δt) |
| a commit period, u_{cc} | |
| Enabled Status cost | =u_{cc}*spec*Δt |
| Disabled Status cost | =u_{cc}*spec*Δt*rRate*Δt |
| Re-enabled Status cost | =u_{cd}*spec*Δt |

Where:
u_{c}=unit cost
spec=rate of usage/consumption (continuous)
qty=qty used/consumed (discrete)
Δt=interval length
ccRate=capital cost rate
rRate=rate of return

Causes State Blocks 2405 transfer the cost of an Activity to the Resource(s) the Activity produces. This is done using methods set out in Dr. Tham's thesis using the information contained in the Activity, Resource, and State Block in question. This means that the State of the Causes State Block parallels that of the producing Activity, and that the rate at which the Resource is produced is defined by a Specification. The total cost of the Causing Activity is spread evenly over all of the different types of produced Resources, and then divided by the number of units of each type of Resource to determine the unit cost.

The cost of Requires State Junctions 2406 represents the cumulative cost of the entities (particularly the State Blocks) it aggregates. The cost of Causes State Junctions 2407 represents the production cost to realize the entities aggregated by the Causes State Junction. This production cost is obtained directly from the connected Activity and is evenly divided amongst all aggregated entities.

To determine the overall cost of an Activity, the cost of each Resource with respect to the Activity (the required cost) is first determined. As previously discussed, the Requires State Block captures this cost. Once these required costs have been determined, the Requires State Junctions aggregate all the Requires State Block costs such that the cost of the Activity is the sum of all the costs of the Resources that it uses.

If the cost of the Activity can be determined, the cost of the Causes State Junction is then known. Consequently, the cost of each Causes State Block aggregated by the Causes State Junction is known. In addition, each Causes State Block can determine how much of its associated Resource was produced by the Activity. This is done by knowing how the Activity is producing the Resource (given by the produce Specification) and, if the Activity is producing the Resource continuously, knowing how long the Activity is executing.

Once the cost and the quantity produced of the Resource have been determined (from the Causes State Block) the Resource can calculate its unit cost. Once the unit cost of a produced Resource is known the cost of Activities that make use of the Resource can be found using the steps described above. To determine the cost of the Cost Object (or end product), this process can be repeated in a “forward-chaining” manner, on all of the Activity clusters leading up to it.

Furthermore, several novel improvements have been made to the cost ontology concepts of Dr. Tham's thesis. These changes expand its capabilities and make it easier to use in practice. The changes are as follows:

1) Multiple Continuous Specifications
The thesis does not discuss the possibility of having multiple continuous specifications for Resources. Supporting multiple continuous specifications, introduces the ability to have the same Resource used or consumed at different rates over different time intervals.
This provides an increased ability to track more complicated activities, for example those that have variable consumption rates. Whereas handling multiple different specifications in this way would have been an onerous task when the work is being performed without a computer system, with a computer system it becomes far easier to track with this accuracy.

2) Unused Status Interval
A new Status interval has been introduced which is not present in TOVE nor Dr. Tham's thesis. The Unused Status was added to accommodate situations in the real-world where a Resource does not have a Status as specified in Dr. Tham's thesis. For example, this Status would be applied when a Resource is not Committed, Enabled, Disabled, or Re-enabled for any of its Requiring Activities.

3) Release Block
The Release Block was eliminated because it is not necessary once the axioms of Dr. Tham's thesis have been implemented in the costing facility of the computer system. Instead of using the Release Block to ensure that a Resource isn't used incorrectly, we make this check programmatically through validation, as described later.

In addition to these changes, some important improvements were made to the manner in which Non-Period and Period Resources are costed. These are described in greater depth now.

Costing Non-Period Resource Statuses

Originally, Dr. Tham's thesis specified three basic formulae for determining the cost of Non-Period Resource Statuses. These equations in the Continuous case are as follows:

Cost of an Enabled or Re-Enabled Interval at Time t:
c_{enabled}(t)=u·rate·(t−tₛₜₐᵣₜ)
Cost of a Committed Interval at Time t:
c_{committed}(t)=u·rate·(t−tₛₜₐᵣₜ)·ccRate·t_{end}−tₛₜₐᵣₜ)
Cost of a Disabled Interval at Time t:

$${c}_{disabled} ( t ) = u \cdot rate \cdot ( t - {t}_{start} ) \cdot ( \frac{{t}_{end} - {t}_{start}}{1 + rRate} )$$

Where:
u—unit cost of the Resource ($/unit)
rate—rate at which the Resource is being consumed (unit/time)
tₛₜₐᵣₜ—the start time of the Status interval
t_{end}—the end time of the Status interval
t—a point in time within the Status interval (tstart<=t<=tend)
ccRate—the capital cost rate (%/time)
rRate—the return rate (%/time)

Analagously, the equations for Discrete Non-Period Resources were as follows:

Cost of an Enabled or Re-Enabled Interval at Time t:
c_{enabled}(t)=u·q
Cost of a Committed Interval at Time t:
c_{committed}(t)=u·q·ccRate·(t_{end}−tₛₜₐᵣₜ)
Cost of a Disabled Interval at Time t:

$${c}_{disabled} ( t ) = u \cdot q \cdot ( \frac{{t}_{end} - {t}_{start}}{1 + rRate} )$$

Where:
q—amount of Resource used/consumed (units)

For the description of the improvement to these formulae for costing Non-Period Resource Statuses, the Continuous case will be used as an example, although the changes are the same for the Discrete case as well.

The Tham thesis suggested that after a Resource exited a committed Status, its unit cost (for the purposes of calculating the cost contribution towards a specific Activity) would increase according to these formulae:

Unit Cost after a Committed Interval
u′=u·(1+ccRate·(t_{end}−tₛₜₐᵣₜ))
Where:
u—unit cost of the Resource at the beginning of the interval ($/unit)
u′—unit cost of the Resource seen by the following intervals ($/unit)

The first area where the current method improves on the thesis is in our determination of the opportunity factor (OCF) which is used to calculate the disabled cost and the increase in the unit cost after the disabled Status interval. In the above equations, the OCF is specified as follows:

$$ocf = \frac{{t}_{end} - {t}_{start}}{1 + rRate}$$

The problem with this method for determining the OCF is that increasing the rRate causes the OCF to decrease in a non-linear fashion, and yields a non-zero disabled cost when the return rate is zero. Given that the cost of a disabled interval is supposed to represent the cost of lost opportunity, increasing the rRate should cause the OCF, and consequently the cost of the disabled interval, to increase in a linear fashion. Therefore, the above formula to calculate the OCF was replaced with the one below that displays the desired characteristics.
ocf=rRate·(t_{end}−tₛₜₐᵣₜ)

Updating the formula involving the OCF to:

Cost of a Disabled Interval at Time t
c_{disabled}(t)=u·rate·(t−tₛₜₐᵣₜ(·rRate·(t_{end}−tₛₜₐᵣₜ)

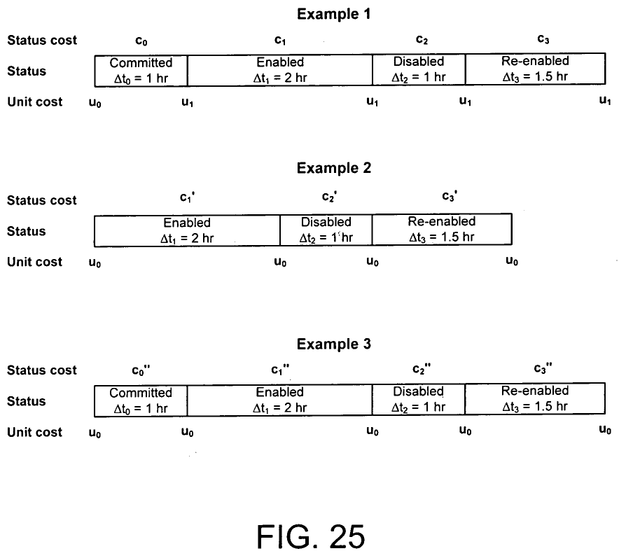

This new formula displays the desirable characteristics of being linearly proportional to the rRate. Using this updated formulae, and assuming initial values:
u₀=10 $/unit
rate=5 units/hour
ccRate=20%/hour
rRate=10%/hour
the Status costs of a Resource with the State shown in Example 1 of FIG. 25 being consumed continuously by an Activity would be calculated as follows:

$$\begin{matrix}{c}_{0} = {u}_{o} \cdot rate \cdot Δ {t}_{0} \cdot ccRate \cdot Δ {t}_{0} \\ = 10 \cdot 5 \cdot 1 \cdot 0.2 \cdot 1 \\ = \$10 \\ {u}_{1} = {u}_{0} \cdot ( 1 + ccRate \cdot Δ {t}_{0} ) \\ = 10 \cdot ( 1 + 0.2 \cdot 1 ) \\ = 10 \cdot 1.2 \\ = 12 \$ \text{/} unit\end{matrix}$$

Error! Objects cannot be created from editing field codes.

$$\begin{matrix}{c}_{2} = {u}_{1} \cdot rate \cdot Δ {t}_{2} \cdot rRate \cdot Δ {t}_{2} \\ = 12 \cdot 5 \cdot 1 \cdot 0.1 \cdot 1 \\ = \$ 6 \\ {c}_{3} = {u}_{1} \cdot rate \cdot Δ {t}_{3} \\ = 12 \cdot 5 \cdot 1.5 \\ = \$ 90\end{matrix}$$

Making the Total Cost of Consuming the Resource:
cₜₒₜₐₗ=c₀+c₁+c₂+c₃=10+120+6+90=$226

However, what is incorrect with the above scenario is the fact that when the committed Status interval is present, the cost of every subsequent Status interval is increased via the unit cost.

Now consider Example 2 in FIG. 25, with no committed Status interval, and the same initial values:
u₀=10 $/unit
rate=5 units/hour
ccRate=20%/hour
rRate 10%/hour
the Status costs would be

$$\begin{matrix}{c}_{1}^{′} = {u}_{0} \cdot rate \cdot Δ {t}_{1} \\ = 10 \cdot 5 \cdot 2 \\ = \$ 100 \\ {c}_{2}^{′} = {u}_{0} \cdot rate \cdot Δ {t}_{2} \cdot rRate \cdot Δ {t}_{2} \\ = 10 \cdot 5 \cdot 1 \cdot 0.1 \cdot 1 \\ = \$ 5 \\ {c}_{3}^{′} = {u}_{0} \cdot rate \cdot Δ {t}_{3} \\ = 10 \cdot 5 \cdot 1.5 \\ = \$ 75\end{matrix}$$

making the total cost of consuming the Resource:

Error! Objects cannot be created from editing field codes.

It can be seen that the difference between c′ₜₒₜₐₗ and cₜₒₜₐₗ is more than the $10 that is attributed to c₀. Therefore, it would be false to say that the cost of having the Resource idle for one hour before it is actually needed is in fact c₀. The above examples show us that this cost (the cost of carrying inventory) is actually cₜₒₜₐₗ−c′ₜₒₜₐₗ=226−180=$46!

From this it is obvious that there is a problem. Since an enterprise should only be penalized for having inventory idle while the inventory is idle, not while it is being used, it makes sense to conclude that increasing the unit cost of the Resource is actually double counting the committed cost.

Eliminating the incorrect increase in the unit cost of a Resource has several positive implications. The first is that the costs that are generated are more accurate. The second is that determining the cost to the enterprise of carrying inventory now correctly works as it is specified in the thesis (by just summing the cost of all of a Resource's committed intervals). The third is that cost calculations to determine the contribution of a committed interval towards the cost of subsequent Internal Resource elsewhere in the EABEM are much simpler.

Example 3 in FIG. 25 shows how using the new methodology with initial values yields the most correct cost:
u₀=10 $/unit
rate=5 units/hour
ccRate=20%/hour
rRate=10%/hour

$$\begin{matrix}{c}_{0}^{″} = {u}_{o} \cdot rate \cdot Δ {t}_{0} \cdot ccRate \cdot Δ {t}_{0} \\ = 10 \cdot 5 \cdot 1 \cdot 0.2 \cdot 1 \\ = \$ 10 \\ {c}_{1}^{″} = {u}_{0} \cdot rate \cdot Δ {t}_{1} \\ = 10 \cdot 5 \cdot 2 \\ = \$ 100 \\ {c}_{2}^{″} = {u}_{0} \cdot rate \cdot Δ {t}_{2} \cdot rRate \cdot Δ {t}_{2} \\ = 10 \cdot 5 \cdot 1 \cdot 0.1 \cdot 1 \\ = \$ 5 \\ {c}_{3}^{″} = {u}_{0} \cdot rate \cdot {Δ t}_{3} \\ = 10 \cdot 5 \cdot 1.5 \\ = \$ 75\end{matrix}$$

Making the Total Cost of Consuming the Resource:
c″ₜₒₜₐₗ=c″₀+c″₁+c″₂+c″₃=10+100+5+75=$190

Non-period Resources are an integral aspect of an EABEM, which is why this improvement upon Dr. Tham's thesis is a critical improvement. There are also some improvements in how Period Resource Statuses are costed.

Costing Period Resource Statuses

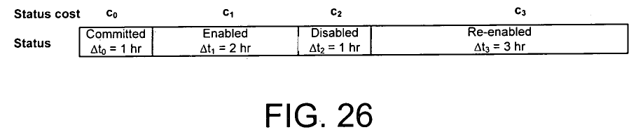

In Dr. Tham's thesis, the cost of Period Resources is determined in the same manner as Non-Period Resources. Consider a Resource with the temporal profile shown in FIG. 26. If the Resource is Non-Period, with the following data properties:
Unit cost: $3/kg
Consume rate: 3 kg/hr
ccRate: 10%/hr
rRate: 25%/hr

This would yield costs:
c₀=$0.90
c₁32 $18.00
c₂=$2.25
c₃=$27.00

If the Resource is Period, with the following data properties:
Unit cost: $5/hr
Consume rate: 1 hr/hr
ccRate: 10%/hr
rRate: 25%/hr

This would yield costs:
c₀=$0.50
c₁=$10.00
c₂=$1.25
c₃=$15.00

However, there is a significant flaw with this approach. Period Resources are Resources that are actually “always on” during the lifetime of an Activity. From a cost perspective, they really cannot be thought of as being “idle” (Committed) or “broken” (Disabled). Only the Enabled Status properly represents how a Period Resource functions in the real-world. Thus, the interval cost of using/consuming a Period Resource during any Resource Status should only use an Enabled Status cost calculation. In order to maintain the Temporal Validity model described later, Period Resources can still be assigned Committed intervals, but these intervals must be costed just as Enabled intervals would.

Using the same temporal profile from FIG. 26 but with the improved approach for costing Period Resources the costs become:
c₀=$5.00
c₁=$10.00
c₂=$5.00
c₃=$15.00

Note here that the ccRate and rRate, which capture lost capital and lost revenue opportunity, are no longer required, and that the Committed costs are determined using the Enabled cost formula.

It is also valuable to be able to determine the opportunity cost associated with Period Resources accurately. For example this would allow a business manager to determine the cost of leased equipment sitting idle. Opportunity costs for Period Resources should also be captured using a different method for Period Resources than for Non-Period Resources to get improved accuracy. This method works as follows:
1. Determine the actual Enabled time of the Period Resource over the Period of Study;
2. Subtract the actual Enabled time (1) from the maximum possible Enabled time in the Period of Study;
3. Determine the proportion of (2) over (1);
4. Multiply this proportion (3) by the rRate for the Period Resource; and
5. Multiply this result (4) by the total cost of the Period Resource, yielding the opportunity cost for the Period Resource over the given Period of Study.

All of these refinements to the costing techniques in Dr. Tham's thesis make costing with the costing facility of the computer system more accurate and efficient. The manner in which costs are generated for Resources is the foundation of Temporal-ABC and as such these improvements are helpful in promoting accurate and realistic costing using the invention.

With it now clear how the costing facility generates costs, it makes sense to discuss some of the innovations that have been made to overcome challenges associated with costing an enterprise in real-time.

One of the most fundamental challenges of the real-time costing facility is to accommodate EABEMs that encompass more entities than for which operational data is available. The typical situation, in fact, is that operational data is only tracked for core processes in the enterprise. While it is possible to truncate the EABEM to only include entities for which real-time operational data is available, it is much more accurate and useful if this dynamic transactional data can be used in combination with relevant but possibly static data for other aspects of the operations. In order to make this possible, the concept of Entity Classification was developed.

Entity Classification

In order to distinguish between Activities for which transactional data is available, and those for which it is not, Activities are separated into two classifications: 1) Trunk Activities and 2) Branch Activities. While other Entity Classifications could be provided to satisfy particular business concerns (e.g. high-risk vs. low-risk), the trunk-branch classification is critical for the operation of the costing facility in a real-time setting, and serves as an excellent example of how Entity Classification can be used.

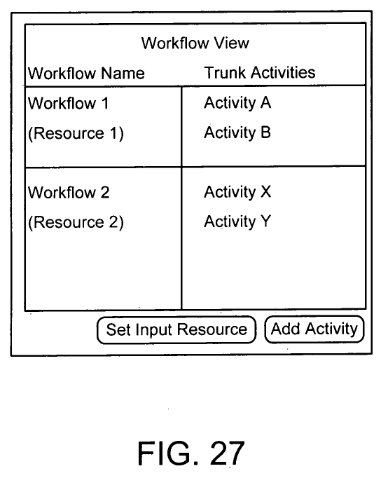

Trunk Activities are the class of Activities that collectively represent a particular “workflow” within the EABEM. This workflow consists of several sequential and contiguous Activities used in the handling of a particular good or product. The operational data source must generate temporal transactions for each and every Trunk Activity assigned in the EABEM. In order to distinguish the Trunk Activities from Branch Activities, the user must specify the Activities which make up the Trunk of a workflow. The user must also classify a Resource as the “input resource” that will be the Resource handled by the Trunk Activities of the workflow. This can be done by selecting the appropriate entities in the user interface of the costing facility, and then using a property page such as the one shown in FIG. 27. These specifications would occur in FIG. 5C at the step for Preparation of the EABEM for continuous real-time usage 519.

Branch Activities are the class of Activities that do not belong to the Trunk of the workflow, and usually support Trunk Activities. The operational data source is not required to generate temporal transactions for Branch Activities.

Using workflows comprised of distinct Trunk and Branch Activities allows for a more accurate and flexible solution for real-time costing in an operational environment. It also is the foundation for more advanced utilization of the cost results, as will be outlined in the description of the billing facility.

Temporal Data Population in a Real-Time

In some circumstances, not even all of the operational cost information for Trunk Activities is available. A particularly common problem is incomplete temporal data for these EABEM entities. The computer system employs a novel way of determining the temporal data necessary to get costs in an EABEM using Temporal-ABC in spite of the incompleteness.

This innovation helps overcome the fact that many enterprises do not have all of the temporal data necessary for real-time Temporal-ABC in an operational data source, although they could still benefit greatly from the use of the data that they do have. To handle situations such as these, an algorithm was invented to “fill in the blanks” with very good approximations to provide valuable Temporal-ABC results where strict adherence to the data requirements would have otherwise prevented the obtaining of any results at all. In contrast to temporal data population in a forensic or predictive cost analysis where Resource Statuses are determined first, in the real-time operation of the costing facility, where temporal data is usually most readily available for Activities, Activity Statuses must be determined first, from which Resource Statuses are then derived. A description of this process follows.

There are two primary operations involved with loading temporal data into the State Blocks of an EABEM.
1. State Importing: Importing temporal data into an Activity
2. State Generation: Generating state information for Activities where no temporal data is given
   State Importing

This operation is performed each time the temporal data is known for a particular Activity. This temporal data can either originate from some operational data source or can be derived based on the State Generation operation. The general algorithm for performing State Importing is described below:

For Each Activity for Which Temporal Data is Known

i. load temporal data into all StateBlocks required by the Activity
   State Generation

This operation is performed each time the temporal information is not known for a particular Activity but is needed for completeness of the EABEM. The typical Activities for which State Generation is required are those Activities that produce Internal Resources. The general algorithm for performing State Generation is described below:

For Each Activity for Which Temporal Data is not Known and Whose Caused Resource is Required by One or more Activities Whose Temporal Data is Known

i. Identify the Resource r produced by the current Activity
ii. Calculate the total quantity q of r required by other Activities in the EABEM
iii. Determine how long the current Activity must execute in order to exactly fulfill q
iv. Generate temporal data based on Step iii, such that at any given time, there is a sufficient quantity of the Resource r to satisfy the consumption requirements of the other Activities

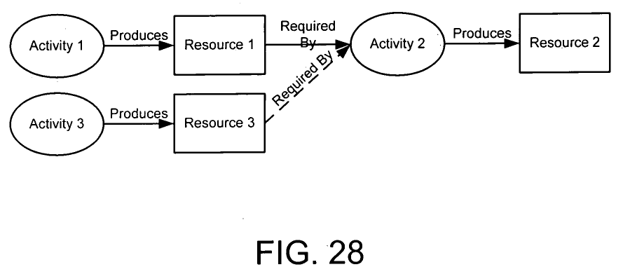

The following example illustrates how temporal data loading would occur in a representative case. Consider the simplified Activity cluster illustrated in FIG. 28. The following information is assumed to be known for this cluster.
a) produce specification for Resource 1: 2 units/hr
b) requires specification for Resource 1: 1 unit/hr
c) produce specification for Resource 3: 0.5 units/hr
d) requires specification for Resource 3: 1 unit/hr

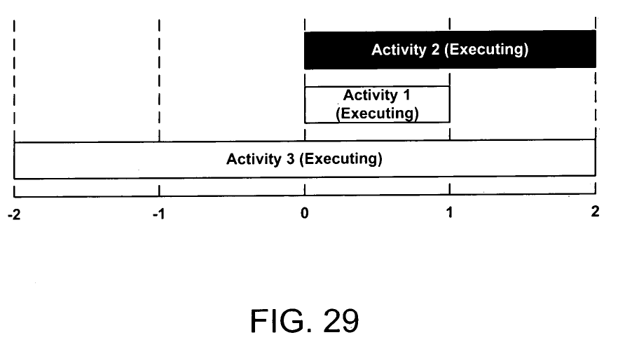

FIG. 29 presents an illustrative example. In this example, a known State is indicated in black, and a generated State is indicated in white.
Example: State Importing+State Generation
   Known State:

Activity 2: Executing for 2 hours, starting at time 0

Generated States:

Activity 1: Executing for 1 hour, starting when Activity 2 starts
Activity 3: Executing for 4 hours, ending when Activity 2 ends

Using the new algorithm described, temporal data population can be performed automatically by the computer system even when provided with incomplete data, making it considerably more powerful and useful.

Validation

A natural extension of this temporal data population challenge is the subsequent requirement to ensure that the data (temporal and otherwise) loaded is in fact valid for the purposes of Temporal-ABC. While this challenge exists with Temporal-ABC in a forensic or predictive study, it is heightened dramatically in a real-time operational scenario, where EABEM sizes are typically larger and data is flowing continuously and in great volumes.

Thus, another novel aspect of the costing facility of the present invention is the manner in which it ensures the consistency of temporal data being loaded into the model, as well as the structural form of the model. This task is performed by a validation facility, which is best understood as a series of “validation routines”. An example of a temporal validation routine is a check that an Activity in the executing Status has all of its conjuncted resources enabled. An example of structural validation is a check that a Resource is not being produced by more than one Activity. The section below explains, by way of illustration, the operation of the validation routines in the validation facility.

The validation facility performs two types of validation routines. The first engages in temporal validation; the second engages in structural validation.

Temporal Validation

Temporal validation ensures that time-related data in the EABEM is consistent. The temporal validation routines are as follows:
Consume validity:
This check is performed at the Resource level on all of the Requires State Blocks that are consuming a Resource. The goal is to ensure that when the Resource is in the Disabled Status at any given period of time for any connected Requires State Block, the Resource must be in either the Disabled or Unused Status (i.e. not Enabled, Reenabled or Committed) by all the other State Blocks for the same time period. This is important because the Disabled Status models a Resource that is broken or unable to operate and thus, it does not make sense that one State Block could be using a Resource while another State Block declares the Resource as disabled.
Use validity:
This check is performed at the Resource level on all of the Requires State Blocks that are using a Resource. The goal is to ensure that two Requires State Blocks never have the same Resource in the same Status at the same time (with the only exception being the Unused Status, by definition). This is important because Resources that are used (rather than consumed) are typically human operators or machines that can only be allocated to one Activity at any given time.
Disjunct validity:
This check takes place at all Requires State Junctions with a disjunctive state.

It ensures that all the aggregated entities of a disjunctive Requires State Junction are Enabled or Re-enabled at different times. This is important because a disjunctive Requires State Junction models part of the enterprise where one and only one of the disjuncted entities is required for the operation of the connected Activity. An example is two bolts, each from a different supplier—the Activity only needs one bolt to execute so the Requires State Blocks representing the temporal usage of each bolt should conform to the disjunct validity.
Conjunct validity:
This check takes place at all Requires State Junctions with a conjunctive state. It ensures that all the aggregated entities of a conjunctive Requires State Junction are Enabled or Re-enabled at the same times. This is important because a conjunctive Requires State Junction models part of the enterprise where several Resources must be available at the same time for an Activity to execute. An example is a nail and a hammer—in order for, say, the “hammering” Activity to occur, both the nail and hammer must be enabled at the same time.
Quantity validity:
This check takes place at the Resource. It ensures that the consumable Resource's available quantity is not over-consumed by connected Requires State Blocks. Clearly, exceeding the available amount of a given Resource indicates an error in modeling.
   Structural Validation
Completeness:
In order to obtain the cost of any entity in the model, there are further checks to guarantee the completeness of the enterprise model:
All entities:
   Valid and (existent) connections
Resource:
   Capital Cost Rate
   Return Rate
   Total Cost, or Cycle Duration and Cost per Cycle
   Total Quantity, or Period of Study
Stateblock:
   Use/Consume/Produce specification
Connection:
Connection validity is required to ensure that the connections between entities are in keeping with the ontological design laid out in Dr. Tham's thesis. Mechanisms for aiding the enforcement of Connection Validity are the Auto-Morphing and Auto-Generation aspects described earlier.
Units of Measure:
This validation measure ensures that the units of measure used for a Resource match the units of measure in the Specification of the associated State Block.

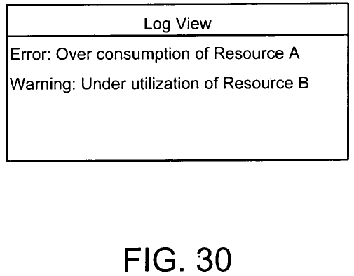

The operation of the validation facility can be illustrated by the following example:
1) The user models an EABEM as described in Sub-process II (FIG. 16).
2) The user creates an Activity called “Fill Boxes” which produces the Internal Resource “Filled Boxes”. It has a Produced State Block which Produces two (2) palettes of Filled Boxes.
3) The user sets the “Filled Boxes” Resource to be consumed by the Activity called “Label Boxes”. It has a State Block which is set to be consuming it for one (1) hour at a rate of four (4) Palettes per hour. The “Label Boxes” Activity produces a Resource called “Labeled Boxes”.
4) The user runs a cost query on the “Labeled Boxes” Resource over one (1) hour.
5) Error messages appear in the costing facility in a property page, such as one shown in FIG. 30, indicating that an over-consumption has occurred.

In this example, the over-consumption results because only two (2) palettes of Filled Boxes are produced, but four (4) palettes are desired for consumption. The Quantity Validity rule gets triggered in this case because the Requires State Block trying to consume the Labeled Boxes cannot consume Labeled Boxes that are never produced.

Determining Period Resource Usage and Cost in Real-Time

Another major challenge of performing Temporal-ABC calculations in real-time arises because of the characteristics of Period Resources, an integral part of Temporal-ABC. Following is a description of novel solutions developed in order to cost Period Resources in real-time.

Whereas the thesis of Dr. Tham costs Period Resources using estimates based upon a priori knowledge of usage of the Resource, in a real-time operational environment, usage can and should be actual and current usages, which will lead to more accurate costs available on-demand.

There are several key requirements imposed by real-time operational and business considerations which constrain the possible manners in which Period Resources can be costed in real-time.
1) Because of changes in Resource usage over time, Period Resource costs change over time. However in order to be utilizable for business (e.g. for accounting or customer billing), costs results must become fixed at some point, and in a manner which does not violate the principles of Temporal-ABC. An effective technique for costing Period Resources must ensure this behavior.
2) To support various business objectives, it is preferred that it be possible to report costs along multiple dimensions (e.g. Customer, SKU type) over arbitrary periods.
3) In order to support dimensional costing, the sum of all the dimensional costs of a Period Resource (e.g. the cost of a Period Resource attributed to Customer A) over any period must be equal to the cost of the Period Resource over the same period.

In order to determine the cost of a Period Resource using Temporal-ABC, three quantities must be determined: the Period of Study (as defined in Dr. Tham's thesis), the cost over the Period of Study, and the usage over the Period of Study. The problem and solution to obtaining these quantities in real-time will be covered in the following sections.

Determining the Period of Study

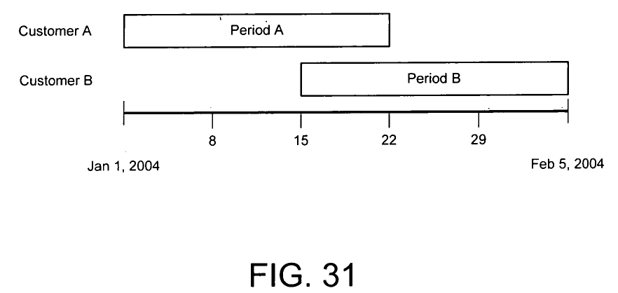

Consider the scenario in FIG. 31 where Period B represents the Reporting. Period for Customer A and Period A represents the Reporting Period for Customer B. Suppose that the cost to serve Customer A over Period A has already been reported such that this cost is now fixed (as per the first requirement). Now, if one wishes to determine the cost to serve Customer B over Period B, it is not immediately obvious how the Period of Study can be set in order to obtain the cost of serving Customer B while satisfying all three requirements.

The intuitive solution to this problem is to set the Period of Study equal to the Reporting Period for each Customer. In FIG. 31, Period A would then represent both the Period of Study and the Reporting Period for Customer A while Period B would represent both the Period of Study and the Reporting Period for Customer B. In doing so, the first two requirements are satisfied in that the costs of both Customers are fixed for each Period of Study and the costs of each Customer “dimension” can be determined over arbitrary periods (in this case, different Reporting Periods). However, as the following discussion will reveal, requirement #3 is not satisfied by this scheme since the sum of the costs of the Period Resource in both Period A and Period B is not equal to the cost of the Period Resource over the time period spanning both Period A and B (January 1^{st} to February 5^{th})

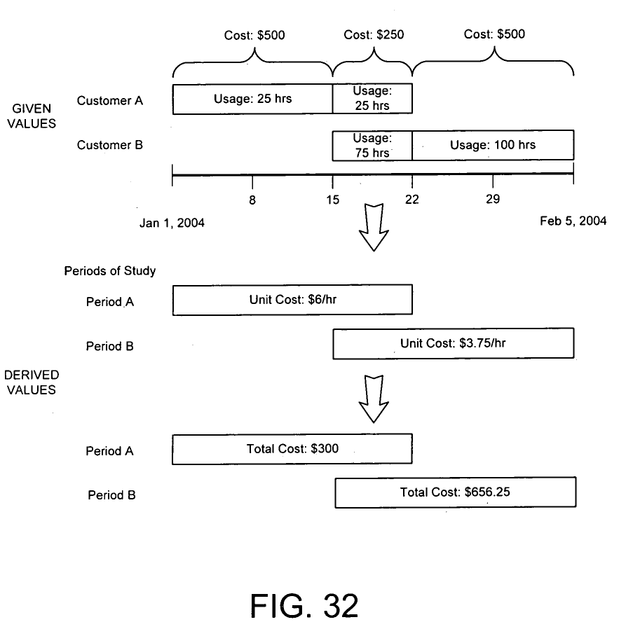

Assume that both Periods described in FIG. 31 make use of a single Period Resource in the manner shown in FIG. 32. To calculate the cost of the Period Resource for Customer A for Period A, the Period of Study is set to the period spanning January 1st to January 22nd.

$$\begin{matrix}unit cost = \frac{cost over period of study}{total usage over period of study} \\ = \frac{\$ 750}{125 hrs} \\ = \$ 6 / hr \\ \begin{matrix}cost of using Resource \\ for Period A\end{matrix} = unit cost \cdot usage over period of study \\ = \$ 6 \text{/} hr \cdot 50 hrs \\ = \$300\end{matrix}$$

To calculate the cost of the Period Resource for Customer B for Period B, the Period of Study is reset to the period spanning January 15th to February 5th.

$$\begin{matrix}unit cost = \frac{cost over period of study}{total usage over period of study} \\ = \frac{\$ 750}{200 hrs} \\ = \$ 3.75 \text{/} hr \\ \begin{matrix}cost of using Resource \\ for Period B\end{matrix} = unit cost \cdot usage over period of study \\ = \$ 3.75 \text{/} hr \cdot 175 hrs \\ = \$656 .25\end{matrix}$$

The check that requirement #3 is satisfied fails because 956.25 (656.25+300) does not equal 1250 (500+250+500). This approach double counts the usage of the Period Resource between January 15 and January 22, and therefore does not meet requirement #3. Other similar approaches to this would also violate requirement #3.

The previous method fails to satisfy requirement #3 because it attempts to fix the unit cost of the Period Resource for only the Reporting Period under consideration. It overlooks the fact that a Period Resource may have already been reported to have a certain cost by other overlapping Reporting Periods. Thus, rather than setting “local” Periods of Study associated with individual Reporting Periods, the novel solution to this problem is to use “global” Periods of Study set on the Period Resource. A new global period of study is established each time any Reporting Period completes. The result is that a Period Resource is attributed a single global unit cost for any moment in time, regardless of the Reporting Period being considered, which allows the total cost of the Period Resources to be properly and consistently allocated (as per requirement #3).

Thus all three of the requirements are satisfied if a new Period of Study is set every time a Reporting Period completes. When fixing a new Period of Study:
a) The start of the period is set to the end of the last Reporting Period that was completed or if the current Reporting Period is the first Reporting Period, the start of the Reporting Period for which the costs are currently being determined.
b) The end is set to the end of the Reporting Period for which costs are currently being determined.

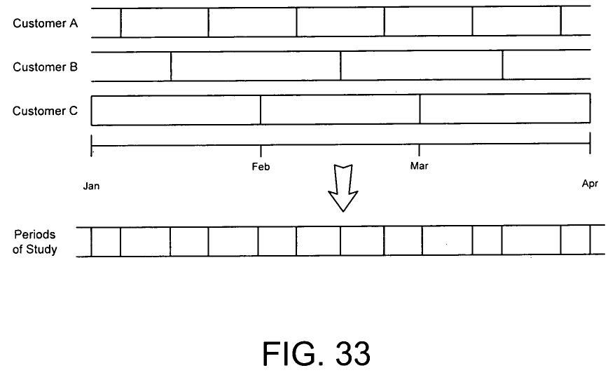

FIG. 33 shows this process after many Reporting Periods have completed. This algorithm ensures that arbitrary Reporting Periods can be used and that the unit cost of the Period Resources will not change for reports that have already been generated.

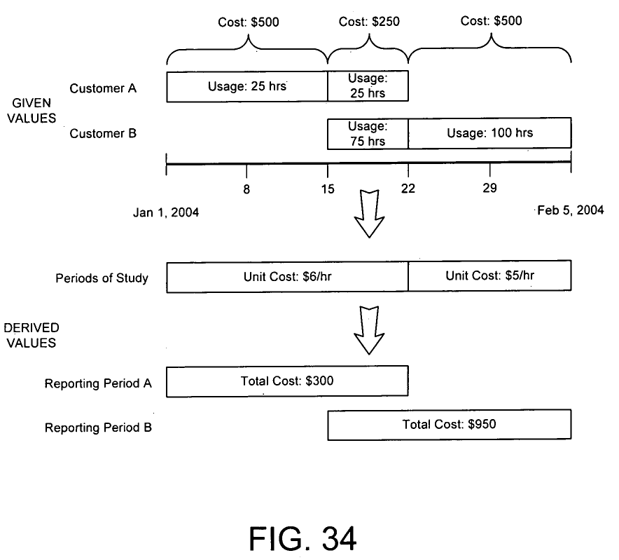

In order to see how the cost of Period Resources is determined using this algorithm and to verify that it indeed meets requirement #3, consider again the Reporting Periods from FIG. 31. Starting with the same example as the previous section, FIG. 34 shows how to arrive at the total cost of the Period Resource for each Reporting Period.

To calculate the cost of the Period Resource for the Reporting Periods, assume that they have both been completed. Therefore, two Periods of Study must be used. As shown in FIG. 34, the first Period of Study spans the entirety of Reporting Period A and the second Period of Study spans the time from the completion of Reporting Period A to the completion of Reporting Period B.
Unit Cost of the Period Resource During the First Period of Study:

$$\begin{matrix}unit {cost}_{1} = \frac{cost over period of study}{total usage over period of study} \\ = \frac{\$ 750}{125 hrs} \\ = \$ 6 \text{/} hr\end{matrix}$$

Unit Cost of the Period Resource During the Second Period of Study:

$$\begin{matrix}unit {cost}_{2} = \frac{cost over period of study}{total usage over period of study} \\ = \frac{\$ 500}{100 hrs} \\ = \$ 5 / hr\end{matrix}$$

To calculate the cost of the Period Resource for Reporting Period A we use the following formula. Note that it must account for the fact that there can be many Periods of Study within a Reporting Period.

$$\begin{matrix}\begin{matrix}cost of using Resource for \\ Reporting Period A\end{matrix} = unit cost1 * usage over \\ Period of Study1 + … + \\ unit costi * usage over Period of \\ Studyi \\ = unit cost1 * usage over Period of \\ Study1 \\ = \$ 6 / hr * 50 hrs \\ = \$ 300\end{matrix}$$

Calculating the cost of the Period Resource for Reporting Period B makes full use of the formula introduced above since the period over which the Period Resource is used spans multiple Periods of Study.

$$\begin{matrix}\begin{matrix}cost of using Resource for \\ Reporting Period B\end{matrix} = unit cost1 * usage over \\ Period of Study1 + … + \\ unit costi * usage over Period of \\ Studyi \\ = unit cost1 * usage over Period of \\ Study1 + unit cost2 * usage over \\ Period of Study2 \\ = \$ 6 / hr * 75 hrs + \$5 / hr * 100 hrs \\ = \$ 450 + \$ 500 \\ = \$ 900\end{matrix}$$

Since $950+$300=$1250, requirement #3 is satisfied. Therefore the algorithm succeeds in fulfilling all of the requirements for the costing of Period Resources in real-time. The importance of this aspect of the invention becomes even more apparent when the Billing Facility is discussed later.

Determining the Period of Study for Incomplete Reporting Periods

As just discussed, in a real-time environment, Temporal-ABC costs change as usage data comes in. However it is important to allow business users to access the most up-to-date cost information at any time, based on usage up to the present. If the cost of a particular Reporting Period is desired before it or another Reporting Period completes, an “unsettled” or estimated cost can be determined. In order to obtain this estimate, a temporary Period of Study must be formed that spans from the end of the last Period of Study to the current moment. This temporary Period of Study can then be used to determine a current best-estimate of the cost of any Period Resource up until the current moment using the procedures outlined in previous sections.

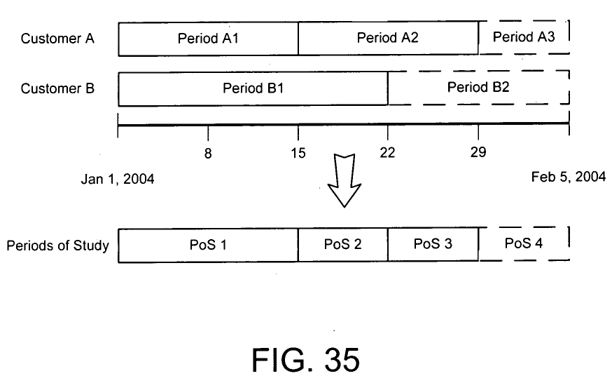

FIG. 35 shows a temporary Period of Study (PoS 4) which can be used to estimate the cost for two incomplete Reporting Periods (Period A3 and Period B2).

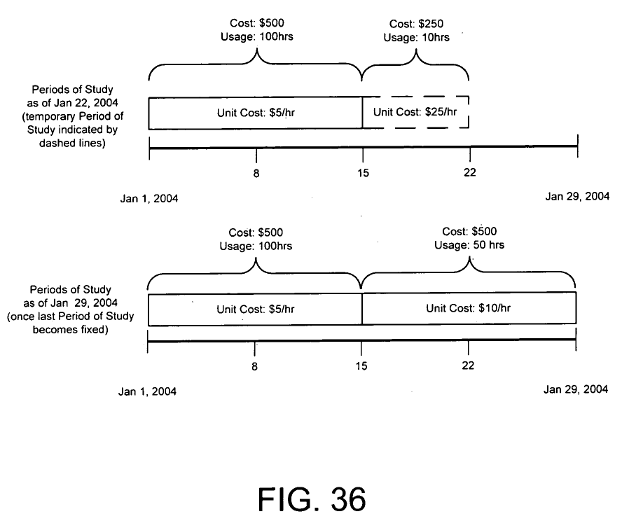

The costs calculated during the temporary Period of Study are only estimates because the usage of a Period Resource isn't guaranteed to be a linear function of time. This means that the usage in a Period of Study that is 2 days long won't be guaranteed to be double the usage in a Period of Study that is 1 day long, even if the 2 day period fully encompasses the 1 day period. This results in the unit cost of the first Period of Study differing from the unit cost of the second Period of Study. Since, as just discussed, the length of a Period of Study isn't fixed until a Reporting Period is completed, the temporary Periods of Study used to calculate costs until that point will only provide estimates of what the final cost will be. FIG. 36 illustrates these points graphically.

Determining the Usage Over the Period of Study

The time information contained in the events from Operational Data Sources is used to determine usage data in real time. For any event, the Activity State information is used to populate Resource States within the EABEM as per the States Importing algorithm described earlier. The Usage data of any Period Resource for an event then corresponds to the State data in the Resource's State Blocks.

For the unit cost of a Period of Study to remain fixed, the usage during that Period of Study must remain fixed. Making use of data coming from an Operational Data Source in real-time presents some challenges to this requirement because rarely will all events that take place during a certain period be available during that period. Usually, some period of time will have to elapse before all events that affect a given Period of Study will be known. This period is called the Usage Settling Period. More formally, this is the length of time after the end of any Period of Study after which the usage during that Period of Study will not be significantly different from its true value.

The implication of this is that the cost for a Reporting Period is not guaranteed to be fixed until the Usage Settling Period has expired.

There are three main factors contributing to the length of the Usage Settling Period:

1. Operational Lag

The lag between when events happen in the enterprise to when they are available in the Operation Data Source. In most cases, this factor will be on the order of at most minutes and therefore negligible in comparison to the other factors.

2. Events will Only be Available Once they have Been Completed

Most Operational Data Sources only register events once they have been completed.

Therefore, in order to capture all data, the Usage Settling Period would have to be as long as the maximum possible length of an event (Activity). The maximum possible length of an Activity is one of the things that can be determined by the forensic analysis of an enterprise's operations 514 (FIG. 5B).

3. Branch Reach Back

Due to the nature of temporal data population for Branch Activity Clusters a phenomenon called Branch Reach Back can occur. This happens when an Activity in a Trunk or its Branch consumes an Internal Resource faster than it can be produced or in a discrete fashion. In this situation, the time needed to perform the Activities in the Branches must be longer than the time specified in the Trunk Activity itself. Thus, in order for the Trunk Activity to have all of its required Resources available while it executes, the Branch Activities may have to begin producing these Resources before the Trunk Activity begins consuming or using them. In effect, the time when the entire set of Activity Clusters in a Branch begins ‘reaches back’ from the time when their Trunk Activity begins.

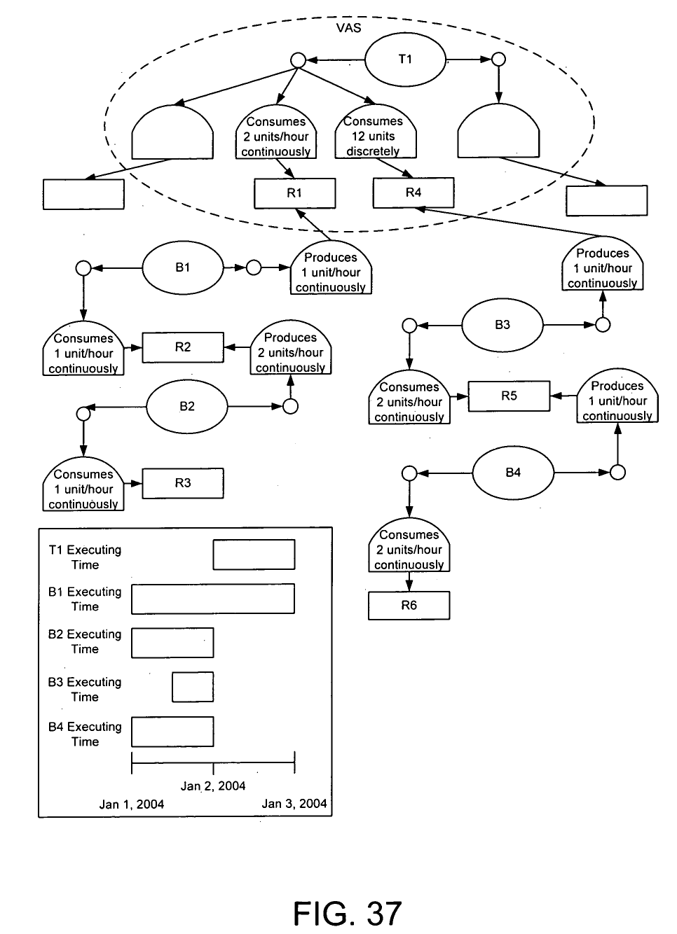

FIG. 37 shows an example of Branch Reach Back. The event information for Trunk Activity T1 specifies that it is to consume Resource R1 continuously from Jan. 2, 2004 to Jan. 3, 2004. However, because Branch Activity B1 only produces R1 at half the rate that T1 consumes it at, B1 must consume Resource R2 from Jan. 1, 2004 until Jan. 3, 2004 in order to ensure that there is always enough R1 available for T1. Since B1 requires Internal Resource R2 to operate and consumes it at half the rate that Activity B2 can produce it at, B2 only needs to execute from Jan. 1, 2004 to Jan. 2, 2004 in order to ensure that there is always enough R2 available.

Trunk Activity T1 must also consume exactly 12 units of Resource R4 at the start of Jan. 2, 2004. Since Activity B3 produces R4 continuously at a rate of 1 unit/hour, B3 must run for 12 hours ending on the start of Jan. 2, 2004. Since B3 consumes Resource R5 at twice the rate that Activity B4 can produce it at, B4 must execute from Jan. 1, 2004 to Jan. 2, 2004 in order to ensure that there is always enough R5 available.

In the above example, the amount of Branch Reach Back is the same for both Resource Chains (defined as all of the entities between a Activity and an External Resource, e.g. all entities from Activity T1 to Resource R3 and all entities from Activity T1 to Resource R6) in the Branches. Therefore, the maximum amount of Branch Reach Back for T1, if T1 executes for 1 day, works out to the Branch Reach Back of both Resource Chains: 1 day.

In the general case, the algorithm for determining the Branch Reach Back for a Trunk Activity requires three main steps:

Step 1: determine the amount of Branch Reach Back at a particular Internal Resource R required by a Trunk Activity that will execute for a given amount of time:
1. If R is required in a continuous fashion, then
   a. Determine the amount of time the producing Activity must execute ([consumption rate of R/production rate of R]*duration of using/consuming Activity)
   b. If the producing Activity executing duration is greater than the using/consuming Activity duration, then:
      i. The reach back at R is equal to the difference between the producing Activity executing duration and the using/consuming Activity executing duration.
   c. Else
      i. There is no reach back at R.
2. Else (R is required in a discrete fashion)
   a. Determine the amount of time the producing Activity must execute (amount of R required/production rate of R)
   b. The amount of reach back at R is equal to the amount of time the producing Activity must execute.

Step 2: determine the total amount of Branch Reach Back for each Resource Chain with the Trunk Activity as its start and an External Branch Resource at its end by summing the Branch Reach Back of each Internal Resource in the Resource Chain.

Step 3: determine the amount of Branch Reach Back for a Trunk Activity by taking the largest of the values found in the previous step.

These steps do not necessarily have to be performed in the order given above. They can actually be intertwined for efficiency reasons.

The Branch Reach Back will usually outweigh the other considerations mentioned in the determination of the Usage Settling Period. Thus the user must wait a period of time equal to the Usage Settling Period after the end of the Reporting Period if completely stabilized and accurate Temporal-ABC® costs are desired. Otherwise, a current-best-estimate of costs can be made in a manner such as that described earlier for incomplete reporting periods.

Determining the Cost Over the Period of Study

As shown above, changing the Period of Study is a requirement for real-time costing. The thesis, however, makes no allowances for this requirement. It assumes that the Period of Study is fixed and known beforehand. In order to lift this restriction, the notion of the “cycle cost” of a Period Resource was introduced. Described earlier, the cycle cost is a simple ratio where the numerator is the Cost per Cycle and the denominator is the Cycle Duration.

Making this small change allows the modeler to enter the cost of the Resource as he or she normally thinks about it (e.g. $400/week) but allows the cost of the Resource to be determined as the Period of Study is dynamically set. Also, this change relieves the modeler of the burden of keeping track of the Period of Study and making it consistent throughout the model.

An example of how the unit cost of a Period Resource is calculated using the cycle cost and a dynamically set Period of Study follows:
Cycle cost of a Period Resource: $40,000/year
Period of Study: 30 days starting Jan. 1, 2001
Usage over Period of Study: 100 hours

$$\begin{matrix}\begin{matrix}Unit cost of \\ Period Resources\end{matrix} = \frac{\$40 , 000}{1 year} \cdot \frac{1 year}{365 days} \cdot \frac{30 days}{100 hours} \\ = \$32 .9 / hour .\end{matrix}$$

The above calculation differs from what is in the thesis because the cycle cost must be scaled to the length of the Period of Study.

One of the assumptions inherent in this method is that we assume that the Cycle cost is constant over any length of time. That is to say that if a forklift is being rented at a rate of $400/week, the enterprise is always paying $400/week every week for as long as the Cycle cost is $400/week. For most Period Resources this is a valid assumption.

Handling Periods of Study with No Usage

A problem inherent to the concept of Periods of Study is that if a Period of Study doesn't contain usage for a Period Resource, then the cost of the Period Resource over this interval will be “lost”. Consider a Period Resource that costs $12,000/year. If the year has been broken up into 12 one month Periods of Study, then the total cost for each period of study is $1000. Now if there is no usage of the Resource in one of these periods, the $1000 allocated to that period will not be associated with any actual usage, or effectively lost.

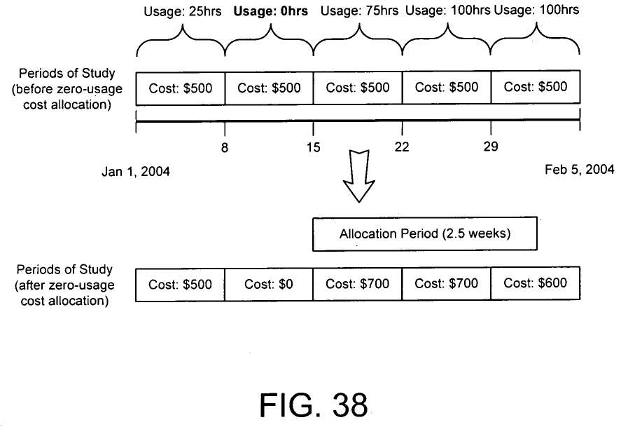

In order to handle this scenario, the cost of any zero-usage Periods of Study will be divided up and added to the cost of a finite number of subsequent Periods of Study. The exact algorithm to accomplish this is described below, and in FIG. 38:
1) Determine the period starting at the end of the zero-usage period of study to which the cost of the zero-usage is to be allocated. Call this period the Allocation Period
2) For each subsequent Period of Study,
   a) Determine the amount of time that the Period of Study overlaps the Allocation Period, and divide it by the total time in the allocation period. Call this amount the Allocation Period Overlap
   b) Add to the cost of those Periods of Study within the Allocation Period an amount of the zero-usage Period of Study's cost that is proportional to the Allocation Period Overlap

If there are zero-usage Periods of Study within an Allocation Period, the above algorithm should be applied to the later zero-usage Period of Study only after the cost of the earlier zero-usage Period of Study has been allocated to it.

The length of the Allocation Period is a decision that will depend primarily on the business objectives of the users. However, when deciding how to determine the length of the Allocation Period, two factors should be considered:
1. If there is a long period of inactivity for a particular Period Resource, the next Activity Instance to make use of that Period Resource should not bear the full cost of the inactivity.
2. The cost of a zero-usage Period of Study should not affect Periods of Study that are sufficiently far away.

As such, the length of the Allocation Period in the costing facility will commonly be equal to the length of the zero-usage Period of Study whose cost is being allocated.

The Period of Study has further implications to costing which must be addressed by yet another aspect of the invention.

Incomplete Activity Duration Determination

Sometimes an Activity does not reach completion within the Period of Study over which its cost must be determined. This is typically because either the Activity has a very long duration, or because the period of study is very small. This poses a problem for costing because the techniques already described for costing an Activity require some sort of completion event to indicate the end of the Activity transaction and the point at which the Activity can be costed. Further, it is important, especially where utilization facilities (described below) are concerned, that the cost be available at any point in time, not just upon Activity completion. As an illustrative example, the storage activity performed by value-added warehouse businesses will be described.

In the value-added warehousing scenario the provision of long term product storage is a key service offered by the warehousing company. However, the manner in which storage is costed as a Value-Added Service deviates slightly from the techniques discussed earlier (e.g. using transactional based Activity and VAS isolation). Specifically, it may not be possible to determine storage Activity durations directly from transactional data, as often the event has not terminated even at the end of a Period of Study, when the cost is to be determined. In cases such as these, durations must be determined using other enterprise data. In the storage case, inventory additions and inventory subtractions serve this purpose.

Thus a novel method for addressing this problem is to calculate storage Activity costs for each Period of Study using an inventory-based approach to determine storage Activity durations. This method assumes that storage Activity clusters (SACs) are still modeled using the EABEM concepts and a different SAC is used for each distinct type of storage. For instance, goods stored using high density shelving would be modeled in a separate SAC from goods requiring cold storage.

For each Reporting Period for a Customer and for each type of SAC, the Warehouse Management System (or similar operational data source), is queried to determine the following information:

1. Starting Inventory:
This is the inventory level for all goods stored by the SAC on behalf of the Customer at the beginning of the Reporting Period

2. Inventory Additions:
These are all the inventory arrivals for all goods handled by the SAC on behalf of the Customer during the Reporting Period.

3. Inventory Subtractions:
These are all the inventory departures for all goods handled by the SAC on behalf of the Customer during the Reporting Period.

4. Held Inventory
This is the amount of inventory that was held in storage using the SAC on behalf of the Customer throughout the entire Reporting Period. This value is derived by deducting all Inventory subtractions from the initial Starting Inventory.

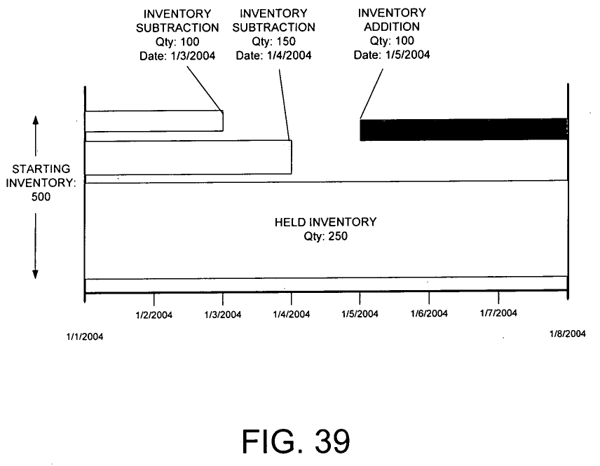

FIG. 39 illustrates these four concepts.

Using the above information, the following three calculations are performed for each Customer and SAC type and summed in order to determine the total storage cost.

1. Held Storage Cost
This represents the storage cost of held inventory. This is calculated as follows:
   Held storage cost=Cost of the SAC over the Reporting Period×Held inventory
The “Cost of the SAC over the Reporting Period” is determined by generating a transaction that spans the entire Reporting Period and using the Temporal Data Population algorithm to load the temporal data associated with that transaction. The cost of the SAC can then be queried using the T-ABC forward-chaining techniques.

2. Added Storage Cost
This represents the storage cost of goods that have been added during the Reporting Period. This is calculated as follows:
   Added storage cost=Error! Objects cannot be created from editing field codes.
   where
   i=Item added to storage
   tᵢ=End of Reporting Period−Date of Addition i
The “Cost of the Addition i over tᵢ” is determined by generating a transaction that spans tᵢ, and using the Temporal Data Population algorithm to load the temporal data associated with that transaction. The cost of the SAC can then be queried using the T-ABC forward-chaining techniques.

3. Subtracted Storage Cost
This represents the storage cost of goods that are subtracted during the Reporting Period. This is calculated as follows:
   Subtracted storage cost=Error! Objects cannot be created from editing field codes.
   where t=Date of Subtraction i−Start of Reporting Period
The “Cost of the Subtraction i over tᵢ” is determined by generating a transaction that spans tᵢ and using the Temporal Data Population algorithm to load the temporal data associated with that transaction. The cost of the SAC can then be queried using the T-ABC forward-chaining techniques.

It should be clear at this point that a number of innovations were necessary to overcome limitations of the prior art for costing enterprise processes accurately, consistently, and comprehensively particularly in real-time.

Utilization of Cost Information (Section V)

Although it is challenging to obtain cost knowledge, generally speaking, it is still of limited use on its own. Its value is only truly realized when it can be utilized to perform and improve aspects of a business. Here is where the method and computer system of the present invention prove their value by supporting facilities for continuous improvement, billing, reporting, decision-making, and product and service pricing activities, hereafter referred to as “utilization facilities”. The forensic and real-time usage of the computer system have been described, but it can also function as a predictive costing mechanism for exploring various “what-if” scenarios.

In the method, the first step of the Utilization Phase, shown in FIG. 5D, is where the real-time costing results are used by utilization facilities such as those mentioned 521. After this, typically results will be tested and validated as a “sanity-check” to make sure the results make sense 522. The cost results should then be used to answer the CQs and CIMs 523 set up in the Preparation Phase of the method. An evaluation of the performance relative to these benchmarks is done 524 to allow for the assessment and documentation of opportunities for action 525 (e.g. continuous improvement opportunities or profit optimization opportunities). An improvement or action plan can be created at this point, which, along with the cost results, can be distributed to the necessary stakeholders for execution 526. If the action required is for continuous improvement 527, a predictive cost analysis can be performed 528 to see what measures will yield the best results before they are implemented by an iteration through this method, starting with the modeling phase. If the desired action is not for continuous improvement, they would then be executed now 529. At this point the next business need or process to consider is determined 530, resulting in the examination of different cost objects 531 or the review and maintenance of processes for the cost object of present concern 532 to ensure they are still relevant and up-to-date.

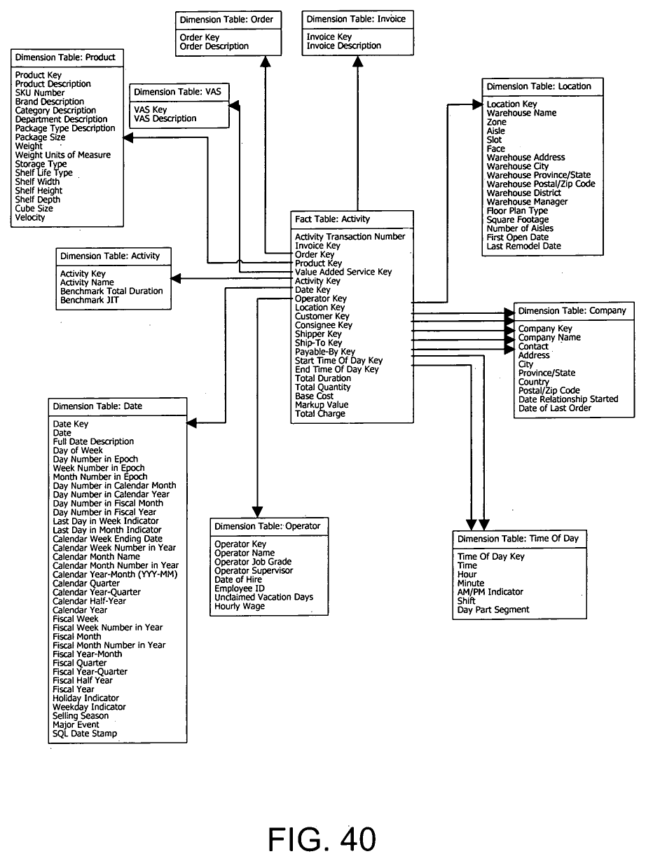

Most of the utilization facilities will require persistence to a mass data storage facility, such as a database or data warehouse. The present invention also includes a data storage facility in order to support these types of applications. This data storage facility 608 is part of the Profit Information System as shown in FIG. 6. The data storage facility handles the actual storage of the EABEM and Temporal-ABC data described. The data storage facility is responsible for not only storing vast amounts of information, but also for making the information quickly and easily available for the utilization facilities. This later responsibility is particularly challenging, therefore a data warehouse architecture is utilized for portions of the data storage facility. To this end, in one particular implementation of the present invention, the data warehouse generally comprises one or more data marts, provided in a manner that is known. Each data mart generally consists of a series of tables that are designed to store the data of a single business process. FIG. 40 illustrates a representative data mart for tracking the billing business process of a value-added warehousing enterprise.

There are a number of innovative aspects of the present invention which support these utilization facilities. As a representative example of one of these utilization facilities in the computer system of the present invention, a pricing or billing facility will be described. A pricing facility supports informed pricing and promotion activities based upon cost information from the costing facility. The billing facility is a further extension of the pricing facility because it includes the execution aspect of pricing, customer billing. As such, the billing facility is one of the most valuable utilization facilities because it unites the cost information from the costing facility with revenue information, thereby creating a detailed and traceable operational profit picture for the processes modeled in the EABEM. In businesses such as a value-added warehouse (VAW) provider, incoming revenue is very closely correlated to operational services provided, making it an ideal enterprise for using the billing facility in combination with the other aspects of the computer system that would be modeling and costing these operational services. As mentioned in the background of the invention, no existing systems or techniques can unite cost and revenue information this effectively or to this detailed a level.

After the costing facility, the billing facility is the other main facility of the PKS 609 shown in FIG. 6. This facility enables enterprises to bill customers profitably by knowing their real Resource costs (based on calculations enabled by the costing facility). Alternately, enterprises can forgo profit on particular operations, but will have clear knowledge of the loss they are incurring.

Activity Groups

One of the novel aspects of the utilization facilities is the concept of Activity Groups, which provide a useful abstraction of the details of EABEM and Temporal-ABC information. The billing facility breaks down the billing process into an element hierarchy of Invoices which are composed of Orders, which are comprised of products or SKUs which have in turn been processed by a distinct set of Value-Added Services, or VASs), for which customers are billed. The correlation between the billing facility and the costing facility, and therefore the revenue and cost, respectively, relies fundamentally on the creation of Activity Groups, in this case Value-Added Service Groups. There are certain challenges that need to be addressed in order to efficiently and correctly support the modeling and costing of Activity Groups such as VAS Groups in a real-time computer system. To understand these general challenges, an examination of VAS Groups specifically will be used.

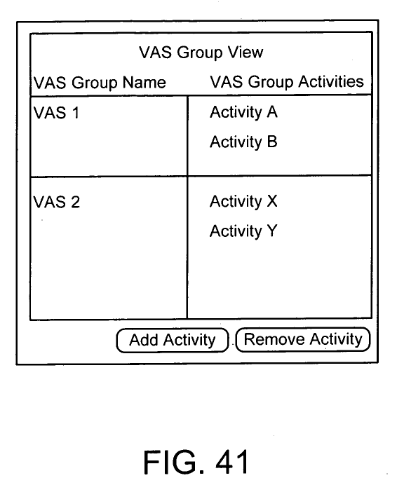

When considering Value-Added Services, Activities are treated as services performed on behalf of a customer rather than just internal operations. For instance in a value-added warehousing enterprise, the Sorting, Inspection, and Filtering Activities could be grouped together as a Quality Check VAS. FIG. 41 provides an example of what a property page might look like in the billing facility for creating and managing VASs. A user can create logical groupings of Activities by selecting them in the EABEM and then adding them to a group using a property page like this.

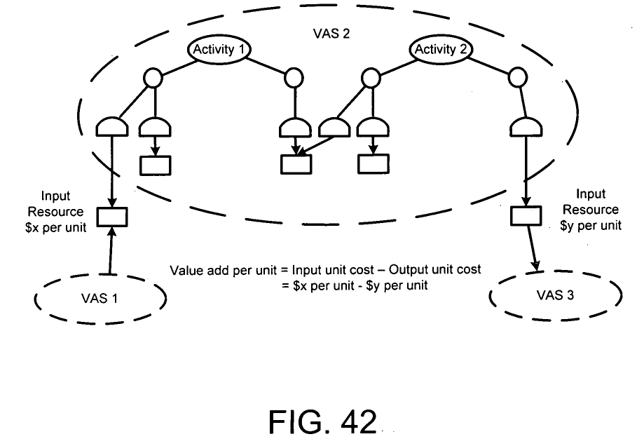

A VAS is thus an Activity Group that represents some service that is performed within the EABEM. The input of a VAS is some Resource that either has no value attributable to the EABEM or possesses some value based on a previous VAS that was performed on the Resource. Specifically, this Resource is an “input resource” as described in the treatment of Trunk and Branch Activities earlier. For example, a “Received flat of eggs” might be an input resource to the Quality Check VAS. Furthermore, since the existence of the VAS is chiefly for the purpose of linking operational costs to relevant revenue generation operations, VAS Activities must correspond to dynamic operational data, in other words, they must be Trunk Activities. The cost of a VAS represents the value-add (i.e. additional cost expenditure) associated with the Activities that were performed on the Input Resource. Typically, the Input Resource and the Output Resource are the same physical Resource, differentiated only by the fact that a service has been performed on it, hence increasing its “value”. This difference is represented by an increase in the Resource's unit cost. FIG. 42 illustrates the generic structure of a VAS Activity Group.

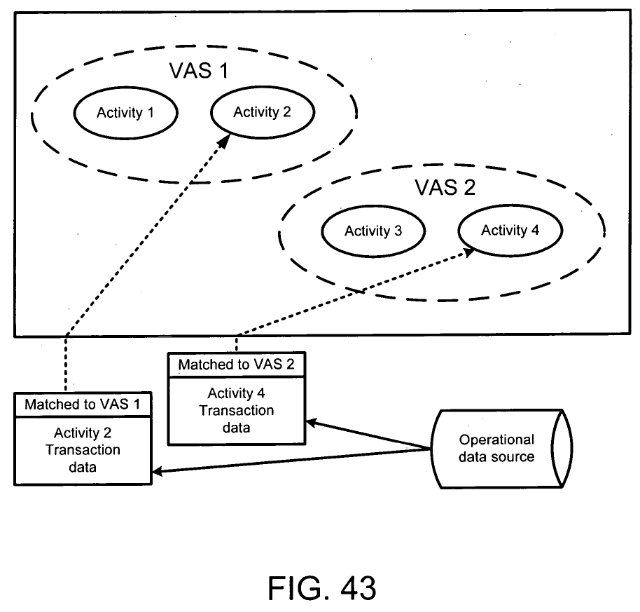

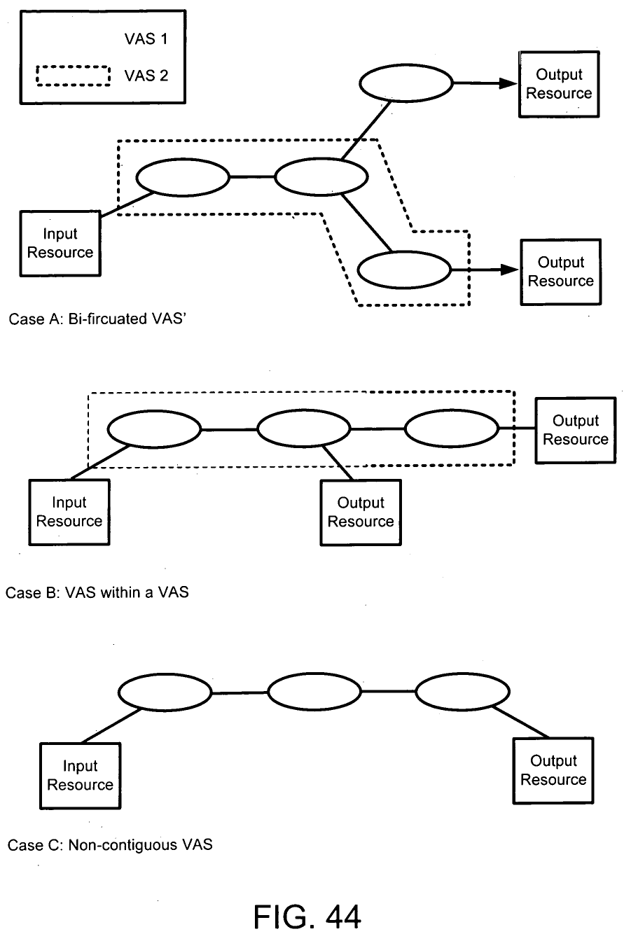

Thus, the introduction of the VAS allows for Activities to be grouped into higher-level Services which can be tailored to the required billing granularity. Although the concept of the VAS is a powerful tool, the construction of VASs must be governed by certain rules. The primary aim of these restrictions is to keep VAS modeling manageable as well as to make the matching of Activity transactions to VAS′ during a real-time operational EABEM simple enough to be realistically feasible in terms of speed and stability. FIG. 43 illustrates the concept of VAS matching. The two VAS modeling rules are:
1) Rule 1: An Activity can only be in one VAS This enables the unique matching of an Activity to a VAS. Thus, as operational data is generated for real-time Activity transactions, there is an immediate and unambiguous association of the service to which a transaction belongs. This restriction eliminates a complex class of VAS′ that share Activities such as the “bi-furcated VAS” and the “VAS within a VAS” as shown in Cases A and B of FIG. 44.
2) Rule 2: Activities in a VAS must be contiguous This also simplifies the mapping of Activity transactions to a VAS and enforces clarity and usability when VAS′ are visually depicted. This restriction eliminates the class of “Non-contiguous” VAS′ shown in FIG. 44 Case C.

The VAS Activity Group is important because it unites cost and revenue information.

However Activity Groups such as the VAS provide a further advantage. Although the construction of an EABEM requires the identification of “significant Activities”, there is no limit to the number of Activities in an EABEM. A large number of Activities affords greater granularity for cost analysis and revenue generation, but such granularity is not always desirable. Excessive detail can also obscure a potentially more useful, high-level, and—in the case of VASs—service-oriented view of the enterprise model. Thus, Activity Grouping is important as a usability mechanism.

Thus building upon the concept of the Trunk and Branch Activities, Activity Groups (such as the VAS), allow the construction of a higher-level (service-oriented) view of an EABEM while still permitting the flexibility and power that an underlying granular model of the enterprise provides. In the case of the Value-Added Service, this seamlessly enables the very important transition from the realm of costing to the world of service-based revenue generation. Another use of Activity Groups could be for the creation of expediting templates which model a group of Activities and Resources which commonly appear together.

In addition to the novel approach needed to model Activity Groups, there are also innovations required to cost Activity Groups. As a representative example of Activity Group costing, the case of the Value-Added Service Activity Group will be used again.

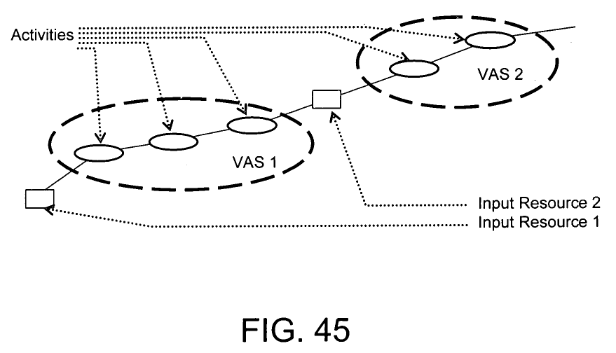

In a warehouse EABEM, a common workflow is that successive Activities will be grouped to form successive VASs, as illustrated in FIG. 45. As outlined in Dr. Tham's thesis, using Activity and Resource cost probing theories, the cost of any Activity in this workflow will depend on previous Activities and Resources. Thus, the cost of the Activities in VAS2 will depend on the cost of Activities in VAS1; specifically due to the contribution of VAS1 to the unit cost of Input Resource 2.

However, the whole notion of a VAS is intended to encapsulate only the additional value (cost) that is contributed by the group of Activities within the VAS. If the cost of VAS2 relies on the cost of VAS1, an external cost dependency is created which inflates the actual “value add” associated with VAS2. Essentially, the challenge is to isolate the cost of a given VAS from all other VASs in order to determine the independent cost contribution, or value add, of the given VAS. This is known as the VAS isolation problem.

The root of the VAS Isolation problem lies in the Internal Resource and the theory of Resource cost probing. By definition, an Internal Resource is a Resource that is produced within the EABEM and whose unit cost is entirely dependent on the cost of producing the Resource. Thus, in the common case where an Input Resource is also an Internal Resource, the production cost of the Input Resource (which is associated with another VAS) will contribute (via the Input Resource unit cost) to the cost of the next VAS that uses/consumes the Input Resource.

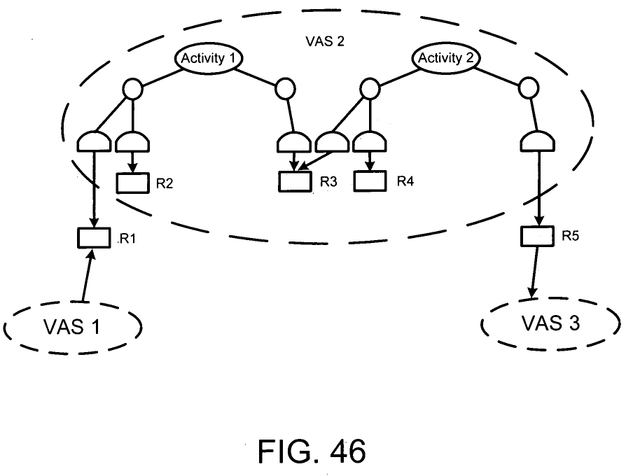

The manner in which VAS Isolation and VAS costing is handled by the billing facility requires a departure from the generalized costing axioms introduced by Dr. Tham's thesis. Specifically, the effect of Resource unit cost probing must be eliminated for both a) the Input Resource of a VAS and b) any Internal Resource that bridges any two trunk Activities within a VAS. Consider the EABEM fragment in FIG. 46. Here VAS 1 produces R1, VAS 2 consumes R1 and produces R5, and VAS 3 consumes R5. In order to properly implement isolation of VAS 2 and to accurately present the value/cost contribution of VAS 2, the following must be performed.
1) Determine the T-ABC cost of Activity 1 using Resource cost probing for R1
2) Subtract the cost of consuming R1 from the cost from (1) in order to eliminate the cost contribution of VAS 1. The result of the subtraction represents the Value-Add of Activity 1 (VAA1)
3) Determine the T-ABC cost of Activity 2 using Resource cost probing for R3
4) Subtract the cost of consuming R3 from the cost from (3) in order to eliminate the cost contribution of Activity 1 since the Value-Add of Activity 1 already accounts for this amount. The result of the subtraction represents the Value-Add of Activity 2 (VAA2)
5) Sum VAA1 and VAA2 to get the total value add of VAS 2

Clearly, this algorithm can be scaled to determine the value add of VASs which have more than two Activities. Steps 3) and 4) can be repeated for each successive Activity i and the resulting VAAi amount can be added to the total value add of the VAS.

Another novel aspect of a utilization facility is the inference engine. The EABEM and Temporal-ABC constructs form a knowledge representation, as understood in an Artificial Intelligence context. As discussed earlier, costing queries function as forward-chaining algorithms on this knowledge representation. With the addition of condition-action rules to this knowledge representation, an inference engine is formed. As an illustration of the use of the inference engine in a utilization facility, the billing facility is examined again.

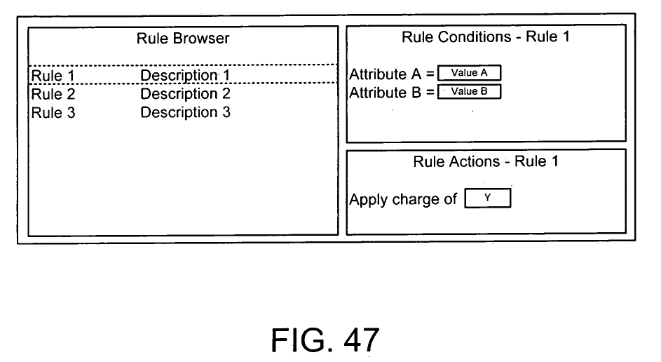

The billing facility includes an inference engine which applies a set of user-defined business rules to take actions based on certain conditions met by the Invoices, Orders, SKUs or VASs. See FIG. 47 for an example of what an interface for creating these rules might look like. The rules take the hierarchical Temporal-ABC costs of these hierarchical elements (described above) and can increase (charge) or decrease (discount) each individual entity in order to modify the final bill accordingly.

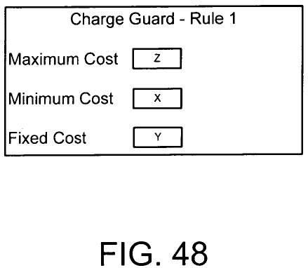

After VASs have been defined, by the method described above, Rules must be defined before a bill is created for a customer. This is done by following these three steps:
1) The user can create a new rule by clicking on the button in the Rule Browser corresponding to the Scope of the rule (Invoice, Order, SKU, or VAS). The Scope refers to the level of the billing hierarchy described above that the rule can affect. A new blank rule will appear in the Rule Browser.
2) The user can then add one or more Rule Conditions which will determine the conditions under which the selected rule will be applied. Conditions are comprised of an Attribute, an Operator, and a Threshold. The Attribute is the characteristic for which the rule is applicable (for example Weight). The Threshold is the value of the Attribute which the rule is evaluated against (for example 10 kilograms). The Operator is the comparison used to evaluate the truth of the Condition (for example Greater Than).
3) The user can then add a Rule Action, which determines what will happen should the Rule Condition(s) evaluate to be true (referred to as the rule “firing”). Two types of Rule Actions can be set: A Profit Charge or a Charge Guard.
   A Profit Charge determines the desired profit that the user would like to get when the rule fires. A Profit Charge is entered as either a positive or negative percentage of the Temporal-ABC cost or as a fixed positive or negative value by which to either increase or decrease the Temporal-ABC cost.
   A Charge Guard is used to keep the charges to the customer within certain desired limits. Because of the dynamic rule-based nature of the billing facility, it is possible for the charge of any individual item (Invoice, Order, SKU or VAS) to become inappropriately large or to remain unnecessarily small. In order to avoid this (e.g. because of contractual obligations or for greater profitability) or to maintain a more traditional approach to billing, the user generating a bill may want to specify a minimum, maximum, or fixed charge for any item on the bill. To do this, the user creates a Charge Guard Rule Action through an interface such as that shown in FIG. 48.
   As an illustrative example, consider a value-added warehouse (VAW) enterprise that sets up a contract with a customer stating that it will handle Product X for the customer but will never charge the customer more than $0.45 for the shipping (a VAS) of a unit of Product X. The VAW however, wants to ensure that it always charges a minimum amount for the shipping service and decides that it will charge at least $0.20 for each unit of Product X that it ships. To implement these constraints we will use two charge guards, a maximum charge guard and a minimum charge guard. In this case, both of the charge guards will be VAS charge guards (because they will be guarding the charge of a VAS) and have the same two conditions. The first condition will be that the name of the VAS is “Shipping” and that the name of the SKU is “Product X”. The max charge guard will have a value of $0.45 and the min charge guard will have a value of $0.20. This will allow the charge for only the shipping VAS of the Product X SKU to vary between $0.20 and $0.45.
   Similarly, charge guards can be set up to modify the charges at any hierarchy Scope level on a bill and can key off of any available attribute.

If there are multiple min or max charge guards on a particular item, the smallest max guard and the largest min guard will be kept. If a max guard is applied to an item that has a min guard that is larger than the max guard, the new max guard will not be applied. The converse situation is also true. In order to eliminate all conflicts, the user can assign priorities to all of the charge guards, so the inference engine can determine which it should apply.

Inference Engine

The inference engine plays a central role in empowering decision-making and providing actionable results for utilization facilities of the computer system.

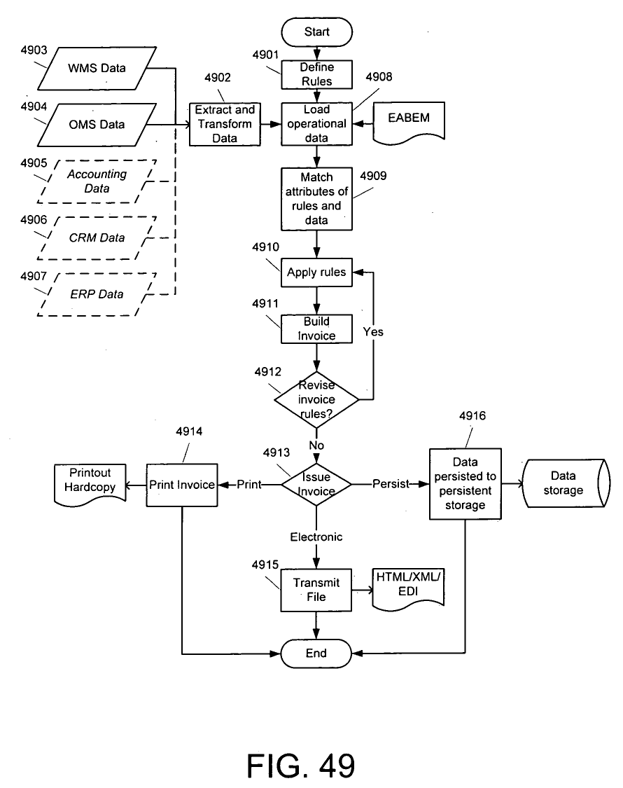

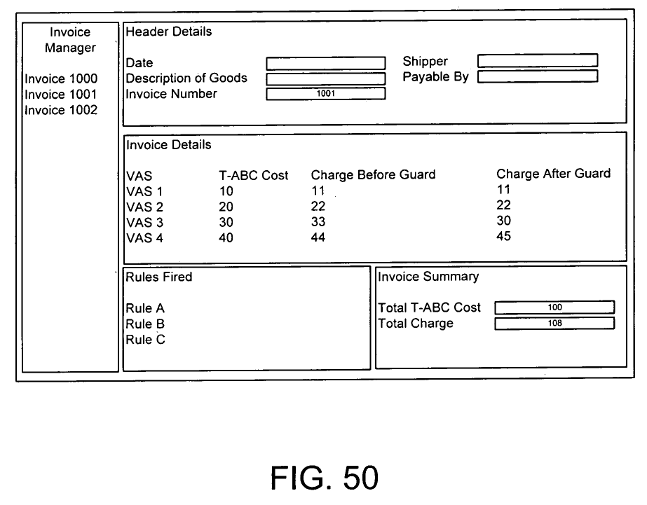

As a representative example of how the inference engine would work with rule-firing in the billing facility, consider FIG. 49. After the rules have been defined 4901, operational data will be extracted 4902 from the necessary operational data sources 4903-4907 and, in the manner described above, loaded into the EABEM in the modeling facility 4902. Then rule matching is performed on the data 4909 and the matched rules are applied to the data 4910. The rule results and costs of the business process are presented to the user in the GUI of the billing facility, as shown in FIG. 50. Based upon these results, an Invoice is generated 4911. At this point, the user can choose what information (e.g. rule information) to show on the final customer-facing bill. The user can also use the graphical user interface to enter invoice-specific information such as customer details, shipping details, and details about the materials being handled. If the business user wants to revise rules applicable to the invoice prior to issuance, they can also do so at this point 4912. Then the user can issue the invoice 4913, in hardcopy 4914, electronically 4915 (e.g. using the Internet, web services, or XML/EDI), and persist it to data storage 4916 which would also allow the postponement of issuance.

Below is a sample of what data input from the operational sources might look like after extraction and transformation 4902. Although not a fully comprehensive list of data, this gives an idea of the type of item identification information, and descriptive, logical, relative, or custom attributes of the item that are required for costing and utilization, and the structure in which they would arrive (actually in XML).

Product Level Data

SKU Type
Weight
Length
Height
Volume
   Transactional Data
General
   Customer
   Order
   Lot
   SKU Type
   Activity code
   Operator ID(s)
   Quantity
Temporal
   Start date
   End date
   Duration
Locational
   Warehouse name
   Sector
   Aisle
   Face
      Detailed Billing

This is a description of the novel way in which we use the system aspect of the invention to create detailed bill visualizations for customers. Whereas an electronic billing interface to a business-to-business system would allow vast data to be transmitted easily, when producing traditional bills, a balance has to be struck to provide valuable information to the customer in a logical manner, but not overwhelm the customer with all of the irrelevant data that is captured by the system.

The bill contains a header with contact information of all the relevant parties, general information about the materials handled in the bill, and important accounting fields.

The body of the bill is where detailed line items with associated charges appear.

These line items would typically be one of the more granular entities tracked by the system, usually a billing rule. Although a higher grouping could be used if desired, billing rule line items are the most useful to customers because it gives them the clearest explanation for a charge. The line items would appear with their respective customer charges, and would be grouped by other higher-level groupings as desired (such as Activity, VAS, SKU, and Order). The cost of a SKU is represented by the cost of the VASs used in processing all units of that SKU type in that order. The cost of an Order can then be represented by the cost of processing all the SKUs in the Order. Finally, the cost of an Invoice is the cumulative sum of all Order costs in the Invoice.

Because the system would be regularly handling thousands of products with many billing rules firing on each of them, the volume of line items would quickly become overwhelming, so further grouping of line items is required for simplification of the bill.

The method of detailed billing simplification works as follows:
1) Rules created in the system are never shown unless they fire.
2) Only show the fired rules that are significant. The user of the system can specify which rules to show explicitly (should they fire).
3) Those rules which are not shown explicitly will be summed together as a single generic line item.
4) Explicitly shown rules may fire numerous times, so the charges and other numeric properties (quantity, volume, mass, etc.) associated with each of these instances are summed together and listed as a single line item for the rule in the bill. The customer typically will not be interested in seeing the charge for each particular instance of the same rule. For the customer's information, average charge per item could be displayed as well.

Following this method for billing simplification is necessary to make invoices a manageable size for the customer, and allowing them to find the information they are interested in as quickly as possible. Combining this billing approach with the system permits detailed billing for any operation modeled in the system.

As described already, the costing, modeling, and billing information referred to above is stored in a data storage facility for historical tracking and to allow utilization facilities such as advanced decision-making tools to leverage this rich repository of cost, revenue, and profit information. One such utilization facility is another aspect of the present invention referred to as the Profit Decision System (PDS). Prior to a system such as the PDS, it has been tremendously difficult to obtain a granular breakdown of expenses and revenue to see how single but important activities and processes affect profit, because no system could leverage vast amounts of Temporal-ABC data from a computer system. In order to capture the data from the PDS system in a manner which empowers decision-making down to the operational level, a reporting facility which can present the output of the PDS in a useful format is required.

The operational information contained in the computer system of the present invention can be used to yield uniquely detailed and timely business performance metrics, potentially in combination with external contextual environment data (e.g. fuel prices, or interest rates). The ability of the system of the present invention to yield reports in real-time on business performance make it especially valuable to business managers working in a rapidly changing and competitive environment. Two metrics that are enhanced particularly by the invention are “cost velocity” and “profit velocity”. These metrics are indications of how costly particular operations or activities are relative to time, and how profitable they are relative to time.

While typically metrics such as these are examined over fiscal periods, and at more global fiscal levels of detail, the invention uses Temporal-ABC to show cost and profit velocity metrics in the reporting facility to the Activity level of granularity, and immediately as the relevant operations are completed. In this way, metrics including but not limited to cost velocity and profit velocity can be seen more immediately and to a more detailed level than possible without the system of the present invention, allowing users of the system to make faster, more informed, and more effective strategies and operational decisions.

The Profit Decision System 610 enables decisions to be formed around cost and revenue data stored to the data warehouse, as particularized above. The operation of the PDS is best understood by reference to FIG. 6. The PDS includes another graphical user interface, which allows users to examine cost and revenue by a wide array of factors and to a very fine level of granularity, both by creating their own queries, or using pre-configured queries. These queries are used to retrieve data which can be formed into reports of interest to a business user.

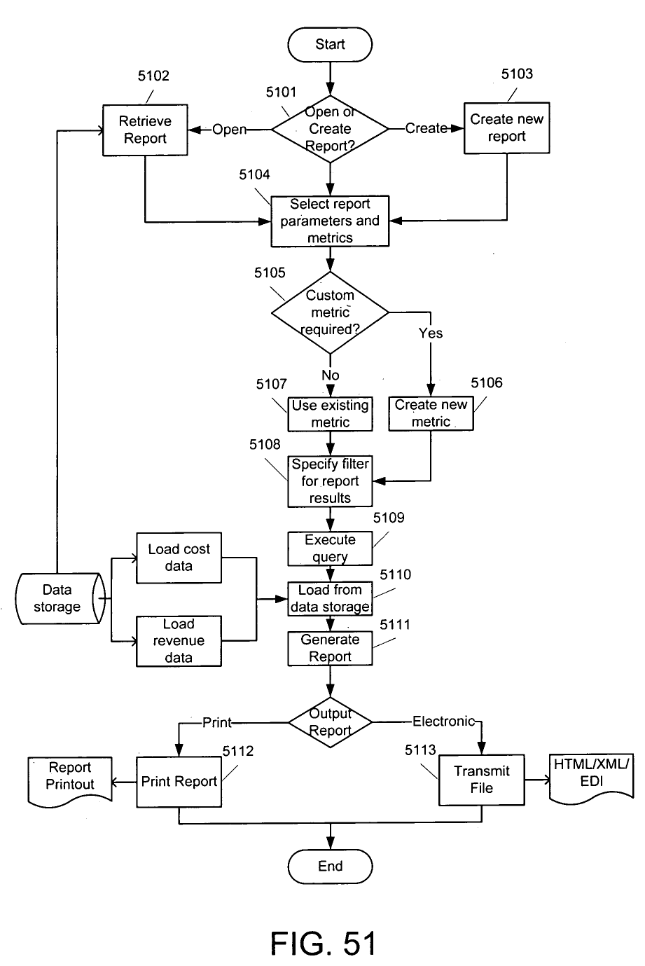

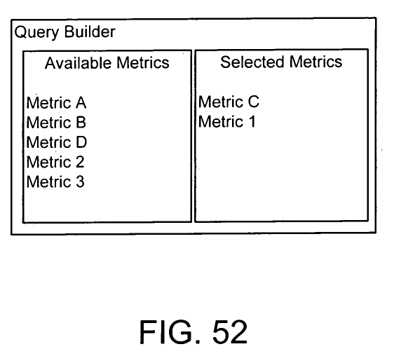

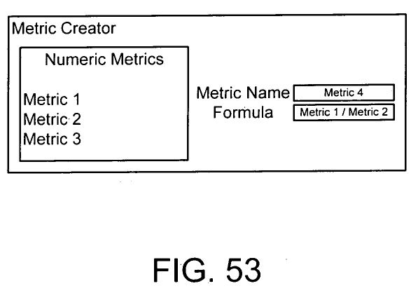

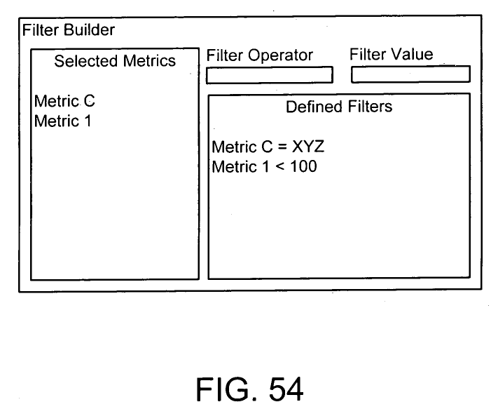

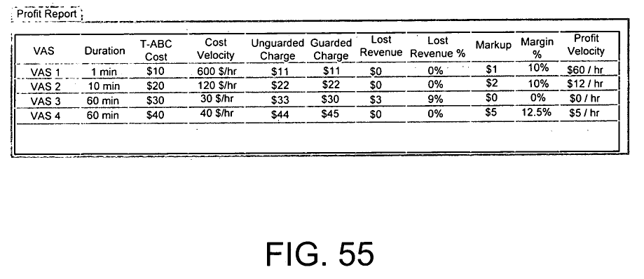

The procedure for creating a profit report is represented in FIG. 51 and is described below. This procedure would occur after the data from the costing facility and billing facility are already in the data storage facility:
1) The user decides 5101 whether to open an existing report 5102 or create a new one 5103.
2) User specifies the metrics and parameters by which he or she would like to analyze their business 5104. This list could include any factors tracked by the operational systems, such as, but not limited to: activities, value-added services, operators, customer information like address, contact person; product information like physical properties or categorical information; time; physical location; and financial information such as cost, price, or profit. A possible interface for choosing these metrics is shown in FIG. 52. The order of the metrics in this list could determine the order of the columns listed in the resultant output. Controlling this order could allow the produced report to function like a “pivot-table”, in a manner that is known.
3) At this point, the user can optionally 5105 define new custom metrics 5106, or use existing metrics 5107 for the report. Through a user interface such as that shown in FIG. 53, the user could combine and manipulate existing metrics with mathematical operators and numbers to achieve new metrics (for example profit margin, or percentage of orders completed in 5 hours).
4) The user will also frequently want to filter the results 5108 from their query so that the report will only show them information over a range that he or she is interested in. A sample interface for performing this filtering is shown in FIG. 54.
5) Then the user is to submit the query for processing 5109, at which point the necessary data is loaded from the data storage facility 5110, and the reporting facility generates the report 5111. A resultant report might look something like FIG. 55.
6) The report can then be outputted in hardcopy 5112 or electronic format 5113, allowing it to be distributed to other interested parties.

By generating reports in this manner, the reporting facility, combined with the costing and billing facility, would then be able to answer typical “multi-dimensional” business intelligence questions like: “What are my sales, in Ontario, for the 10 days prior to Christmas?”, or “What were my 2 most profitable customers over the last 5 years?”, or “Show me which of my warehouses have the lowest personnel costs”. However with cost visibility down to the operational level, more advanced answers can also be answered by this aspect of the current invention. A business user could try to identify best practices by asking, “Who are the managers whose warehouses achieve more than 5% margin on all cross-docking activities?” The reporting facility would also be able to answer questions such as “What happened to the profitability of my services for large customers when I started serving small customers?” which require a deeper view of profitability tied to operations. The reporting facility would also be able to leverage the temporal cost information in the data, making it possible to also answer questions like: “How would my operational costs differ if my kitting activities took 10% less time?”

As illustrative examples of how the reporting facility of the invention enables uniquely operationally-based business intelligence on-demand, consider the following two examples for a value-added warehousing enterprise.

### EXAMPLE 1

### Operational and Tactical Decision Support

The following is an example of how the reporting facility could reveal a unique continuous improvement or tactical opportunity. Consider the scenario where Albert and Rose are managers of two different warehouses both for Company Z. Using the method and system of the present invention, they produce a report that reveals that Albert makes an average margin of 3% on cross-docking services, while Rose makes an average margin of 5%. Since they both work for Company Z, they charge the same amount for their cross-docking service, however, Rose's operators manage to cross-dock in about 40% less time than Albert.

This report has provided Temporal-ABC backed insight which provides Albert with a number of decision opportunities. If he wants to take a operational approach, he can examine Rose's operations with a continuous process improvement approach and make changes to his processes to reduce operational times and costs to achieve the same margin. If he wants to take a tactical approach, he can examine the product-mix that Rose handles and if he feels that the products she is handling are more profitable to handle, he can either seek out customers with these types of goods to handle in an effort to achieve higher margins, or he can start charging for the additional services (e.g. the necessarily slow handling of delicate goods) he is providing to his customers by using the rule mechanisms of the detailed billing facility of the present invention.

### EXAMPLE 2

### Strategic and Tactical Decision Support

The following is an example of how the reporting facility could reveal a unique strategic or tactical opportunity. Consider the scenario where William runs a value-added warehouse, and has decided that growth and success for his company will depend on a more diverse cross-section of customers. He has brought in some business from a number of small and large-sized customers to compliment his existing medium-sized customers. Creating some basic reports he sees that he has higher net income since he brought on the new customers, but that his per customer profitability has dropped for his original medium-sized customers. In order to find out why, he can use the system of the present invention to see what operations in his business cost before and after the introduction of the new customers. Suppose in this scenario that his operational insight reveals that his cost to serve small customers is higher, and his cost-to-serve large customers is lower, than that for his medium-sized customers. William can now make some crucial decisions based on this uniquely insightful knowledge. A tactical approach would be to maximally optimize profits by phasing out the smaller customers because they are too expensive to serve, and to instead focus entirely on the more profitable larger customer market. However a strategic approach is also possible, which may recognize that there is too much competition in the larger customer market already, and that the smaller customer market offers far more growth and long-term profit opportunity despite the higher cost-to-serve.

Decisions of this complexity must be made in an educated, intelligent fashion for consistent, reduced-risk, and predictable success. The system of the present invention supports these decisions with unparalleled power because of the unambiguous and operationally traceable nature of Temporal-ABC costs, combined with the real-time operational capabilities of the computer system of the present invention.

One of the most common consequences of using a utilization facility of the computer system, such as those discussed, is the exploration of continuous improvement opportunities. In these situations, a predictive analysis of an EABEM is often desirable. A predictive analysis involves the partial or complete population of the EABEM model with hypothetical data to determine the effect that achievement of these target values would have on Temporal-ABC costs in the EABEM. Using queries of the theoretical model to answer these “what-if” questions is immensely valuable for the purposes of continuous improvement (for example, Target Costing), but also for planning, and budgeting purposes because it allows decisions to be made in a cost-informed fashion. As discussed earlier, cost queries are performed using forward-chaining algorithms. Analogously, certain “what-if” queries can be achieved through the application of “backward-chaining” algorithms on the EABEM and Temporal-ABC data. Predictive cost analyses 528 would typically take place in this utilization phase of the method, as shown in FIG. 5D, although they could be done at other times as required.

1. A method of temporal, activity-based cost modeling for an organization comprising the steps of:
(a) Determining a plurality of data types contributing to costs related to one or more activities of the organization;
(b) Capturing data elements corresponding to the data types;
(c) Creating an ontological enterprise model based on the data elements, by:
(i) applying a Temporal Activity Based Costing Model to the organization;
(ii) testing the applicability of the Temporal Activity Based Costing Model to the organization; and
(iii) adjusting the Temporal Activity Based Costing Model to the organization, based on (ii); and
(d) Configuring a computer system to apply the ontological enterprise model to the data elements on an ongoing basis, such that the ontological enterprise model yields information about the costs of the activities for defined periods of time.

2. The method as claimed in claim 1, comprising the further step of interpreting the information about the costs of the activities to do one or more of the following:
(a) Defining strategies for improving resource utilization; and/or
(b) Defining improved pricing strategies from the perspective of profit realization.

3. The method as claimed in claim 1, comprising the further steps of:
(a) Analyzing the organization so as to obtain background information; and
(b) Planning the application of the Temporal Activity Based Costing Model to the organization based on the background information.

4. The method as claimed in claim 1, comprising the further step of extracting the data from one or more data sources by operation of a profit information utility, so as to derive cost information.

5. The method as claimed in claim 4, comprising the further step of deriving cost knowledge from the cost information, by operation of a profit knowledge utility.

6. The method as claimed in claim 5, comprising the further step of creating temporal cost-based bills by operation of the profit knowledge utility.

7. The method as claimed in claim 5, comprising the further step of creating a price optimizing report in connection with the creation/delivery of goods or services by operation of the profit knowledge utility, and utilizing the price optimizing report to define optimized pricing strategies.

8. A method of temporal, activity-based cost modeling for an organization comprising the steps of:
(a) Conducting an organization review including one or more of the following steps:
(i) Identifying organization/customer costing requirements and business objectives;
(ii) Identifying products or services of interest so as to establish a plurality of cost objects;
(iii) Identifying a plurality of stakeholders within the organization, including organization personnel, suppliers, and/or organization clients, and obtaining from the plurality of stakeholders feedback regarding one or more of project risks, limitations, current costing practices and a project plan; and
(iv) Cataloguing a plurality of activities of the organization;
(b) Establishing a plurality of criteria for assessing the success of the temporal, activity-based cost modeling, such criteria including one or more of competency questions, continuous improvement metrics, and the influence of each of these on organization performance;
(c) Probing the plurality of activities so as to identify a plurality of data types contributing to costs related to the plurality of activities;
(d) Coordinating access to the data types from one or more data sources, so as to enable access to temporal data corresponding to the data types;
(e) Creating an ontological enterprise model for enabling the analysis of the temporal data by:
(i) applying a Temporal Activity Based Costing Model to the organization;
(ii) populating the Temporal Activity Based Costing Model with the temporal data; and
(iii) performing forensic analysis on the populated Temporal Activity Based Costing Model, and testing and validating the Temporal Activity Based Costing Model; and
(f) Configuring a computer system to process the temporal data in real time based on the Temporal Activity Based Costing, thereby generating real time costing information.

9. The method claimed in claim 8, comprising the further step of accessing the computer system, and thereby initiating one or more software functions linked to the computer system that enable:
(a) pricing functions;
(b) billing functions;
(c) decision support functions;
(d) continuous improvement functions;
(e) profit functions, accounting functions;
(f) customer relationship management functions; and/or
(g) enterprise resource planning functions.

10. The method claimed in claim 8, whereby the probing of the plurality of activities consists of:
(a) Establishing a list of organization activities;
(b) Determining the resources required by each of the organization activities; and
(c) Modeling each of the required resources by determining whether each such resource is:
(i) Used or Usable by the particular activity, and if so designating the resource as being “Used” or “Usable” by that activity; or
(ii) Consumed or Consumable by the particular activity, and if so designating the resource as being “Consumed” or “Consumable” by that activity; and
(iii) Determining whether each particular resource is caused by another activity, whereby if the particular resource has been caused by another activity, designating that resource as an Internal Resource, and if the particular resource has not been caused by another activity, designating the resource as being an External Resource; and
(iv) Establishing whether a particular resource is required by any subsequent activity, whereby if the particular resource is not required by a subsequent activity, then designating the particular resource as a final cost object, and if the particular resource is required by a subsequent activity, classifying the resource as an Internal Resource and probing any other activity requiring this particular resource; and
(v) Establishing that all required resources have been modeled.

11. The method claimed in claim 10, comprising the further step of classifying the organization activity, whereby if:
(a) All resources required by the activity are external, the activity shall be considered a Frontier Activity; and
(b) Otherwise the activity is considered an Interior Activity.

12. The method claimed in claim 8, comprising the further step of defining for, and linking to, each required resource a temporal state block, whereby the state of an activity can be derived automatically from the state(s) of the required resources for that activity.

13. The method claimed in claim 12, whereby the temporal data defines one or more state blocks corresponding to the time that the resource has a particular time limited state consisting of one or more of the following states:
(a) Committed;
(b) Enabled;
(c) Disabled; or
(d) Re-enabled; or
(e) If the resource is neither (a), (b), (c) or (d), then the resource is Unused.

14. The method claimed in claim 13, further comprising the step of populating the state blocks with temporal data so as to define the state of the various resources for a current time unit, and the duration of such current time unit.

15. The method as claimed in claim 14, comprising the further step of combining the states of the various resources:
(a) Conjunctively where the required resources are required conjunctively; and/or
(b) Disjunctively where the required resources are required disjunctively.

16. The method as claimed in claim 15, comprising the further step of defining an activity cluster consisting of an activity, one or more associated resources, at least one state block for each such resource, and at least one state junction corresponding to each of the at least one state block, the state junction defining whether the relationship between the at least one state block and the activity is conjunctive or disjunctive, and applying a plurality of temporal and/or structural validity rules to the cluster so as to enable the aggregation of the states of the plurality of resources to define a temporal profile for the activity, and deriving from such temporal profile cost information regarding.

17. The method as claimed in claim 16, comprising the further step of initiating a costing routine, thereby enabling a user to obtain cost information for an activity by:
(a) Identifying one or more activities for which the user wishes to obtain cost information;
(b) Selecting a type of cost query; and
(c) Specifying the period of time over which the cost query is to be executed;
Whereby the costing routine determines the real time cost of the activity based on temporal cost information for any associated resources or activities, including the then current status of any associated resource.

18. The method as claimed in claim 8, comprising the further step of initiating a costing routine, thereby enabling a user to obtain cost information for a resource by:
(a) Identifying one or more resources for which the user wishes to obtain cost information;
(b) Optionally selecting the particular activity linked to the resource for which the user wishes to obtain costing; and
(c) Specifying the period of time over which the cost query for the resource is to be executed;
Whereby the costing routine determines the real time cost of the resource, including as it relates to a particular activity, based on the current state of the resource.

19. The method claimed in claim 16, comprising the further step of initiating an auto-morphing routine that, in response to a state block change, applies a plurality of rules defining dependencies of statues on resource attributes, thereby enabling the automatic updating of data populated to the Temporal Activity Based Costing Model.

20. The method claimed in claim 16, comprising the further step of initiating an auto-generation routine whereby state blocks and state junctions are automatically created for the activities and resources.

21. The method claimed in claim 5, comprising the further step of generating temporal cost information by preparing the Activity Based Costing Model for real-time usage by specifying a plurality of properties for the Activity Based Costing Model for obtaining cost information in real-time and/or for linked software utilities to process the cost information.

22. The method claimed in claim 5, comprising the further step of providing in the Temporal Activity Based Costing Model multiple continuous specifications for resources, including the same resource being used or consumed at different rates over different time intervals.

23. The method claimed in claim 5, comprising the further step of determining the cost of non-period resource statuses by defining a proportional relationship between the rate used to quantify the opportunity cost associated with capital that could otherwise have been invested in another project or interest bearing financial instrument, and the opportunity factor associated with the resource.

24. The method claimed in claim 5, comprising the further step of organizing activities into:
(a) Trunk activities, consisting of activities related to a workflow for creating a particular product or service; and
(b) Branch activities, consisting of activities that are not part of the workflow, but support the Trunk activities.

25. The method claimed in claim 5, comprising the further steps of:
(a) Determining that not all temporal data is available for populating the Temporal Activity Based Costing Model; and
(b) In response to (a), inferentially generating unavailable status information.

26. The method claimed in claim 25, whereby the inferential generation of status information includes:
(a) Identifying the resource produced by a current activity for which temporal data is not known:
(b) Calculating the total amount of the resource required by other activities;
(c) Determining how long the current activity must execute in order to exactly provide the total amount of the resource; and
(d) Generating temporal data based on (c), such that at any given time there is a sufficient quantity of the resource to satisfy the consumption of the resource by the other activities.

27. The method claimed in claim 5, comprising the further step of initiating a plurality of temporal validation routines and structural validation routines.

28. The method claimed in claim 5, comprising the further step of costing the use of a resource over a period of time by:
(a) Determining the period of study for the period resource by setting a new period of study each time a reporting period is completed;
(b) Optionally determining the period of study for incomplete reporting periods;
(c) Determining real-time usage over the period of study;
(d) Determining the real-time cost of the resource during the period of study;
(e) Optionally accounting for the cost of a resource during periods wherein the resource is not used; and
(f) Optionally accounting for the duration of an activity that is longer than the period of study.

29. The method claimed in claim 6, comprising the further step of initiating a billing routine, the billing routine defining a plurality of invoice templates including orders, the orders corresponding to products or SKUs, whereby the products or SKUs, by operation of the billing routine, being processed based on a defined set of Value-Added Services.

30. The method claimed in claim 5, comprising the further step of activating a pricing routine, whereby costing information is generated or accessed by operation of the pricing routine whereby the pricing information is correlated with hypothetical revenue information.

31. The method claimed in claim 30, whereby the further step of activating a billing routine whereby the costing information is correlated with actual revenue information.

32. The method claimed in claim 29, comprising the further step of billing customers for Value-Added Services by:
(a) Defining Value-Added Services that correspond to Trunk Activities;
(b) Defining the Value-Added Services based on a grouping of services; and
(c) Modeling the Value-Added Services such that an activity can only be in one Value-Added Services grouping, and such that activities in a Value-Added Services grouping must be contiguous.

33. The method claimed in claim 32, comprising the further step of eliminating the effect of resource unit cost probing for input resources to a Value-Added Services grouping and any internal resource that bridges any two Trunk Activities within a Value-Added Services grouping.

34. The method claimed in claim 29, comprising the further steps of:
(a) Defining a set of billing rules by operation of the billing utility;
(b) Selecting the conditions under which a particular billing rules will be applied;
(c) Defining one or more actions to be taken if the conditions of (b) are present.

35. The method claimed in claim 34, comprising the step of defining one or more actions to be taken if conditions under which a particular billing rule will be applied consisting at least one of:
(a) A profit charge; or
(b) A charge guard.

36. The method claimed in claim 6, comprising the further step of initiating the computer system to perform a backward chaining query so as to determine based on a target cost for a target activity or product thereof, possible cost scenarios for associated activities or resources linked to the target activity or product.

37. A computer system for enabling temporal, activity-based cost modeling comprising:
(a) A computer; and
(b) A computer application loaded on the computer, the computer application including computer instructions for defining on the computer system a profit knowledge utility, the profit knowledge utility being operable to:
(i) Process data elements corresponding to a plurality of data types contributing to costs related to one or more activities of the organization, so as to create an ontological enterprise model based on the data elements, by:
(A) applying a Temporal Activity Based Costing Model to the organization by means of a modeling utility;
(B) enabling a user to test the applicability of the Temporal Activity Based Costing Model to the organization; and
(C) further enabling the adjustment of the Temporal Activity Based Costing Model to the organization, based on (B); and
(D) Applying the ontological enterprise model to the data elements on an ongoing basis, such that the ontological enterprise model yields cost information regarding the costs of the activities for defined periods of time.

38. The computer system claimed in claim 37, wherein the profit knowledge utility is further operable to enable one or more users to do one or more of the following, via one or more graphic user interfaces:
(a) Defining strategies for improving resource utilization; and/or
(b) Defining improved pricing strategies from the perspective of profit realization.

39. The computer system as claimed in claim 37, wherein the computer application further includes computer instructions for defining on the computer a profit information utility, wherein the profit information utility is operable to extract the data from one or more data sources including one or more of (a) a warehouse management system, (b) an order management system, (c) an accounting system, (d) a customer resource management system, (e) an ERP system, or (f) an external system such as the Internet, so as to derive cost information.

40. The computer system claimed in claim 37, wherein the profit knowledge utility is further operable to derive cost knowledge from the cost information.

41. The computer system claimed in claim 40, wherein the computer application defines on the computer a billing application or billing engine linked to the profit knowledge utility that is operable to create cost-based bills based on the cost information.

42. The computer system claimed in claim 41, wherein the profit knowledge utility is further operable to create one or more price optimizing reports in connection with the creation/delivery of goods or services, and to enable one or more users to utilize the price optimizing report to define optimized pricing strategies.

43. The computer system claimed in claim 37, wherein the profit knowledge utility enables one or more of the following functions:
(a) pricing functions;
(b) billing functions;
(c) decision support functions;
(d) continuous improvement functions;
(e) profit functions;
(f) accounting functions;
(g) customer relationship management functions; and/or
(h) enterprise resource planning functions.

44. The computer system claimed in claim 37, wherein the computer application further includes a graphic user interface that is operable to assist one or more users to:
(a) Determine the resources required by each of the organization activities; and
(b) Model each of the required resources by recording by user input to a model interface linked to the modeling utility, whether each of such resource is:
(i) Used or Usable by the particular activity, and if so designating the resource as being “Used” or “Usable” by that activity; or
(ii) Consumed or Consumable by the particular activity, and if so designating the resource as being “Consumed” or “Consumable” by that activity; and
(iii) Determining whether each particular resource is caused by another activity, whereby if the particular resource has been caused by another activity, designating that resource as an Internal Resource, and if the particular resource has not been caused by another activity, designating the resource as being an External Resource, and recording such designations to the model interface; and
(iv) Establishing whether a particular resource is required by any subsequent activity, whereby if the particular resource is not required by a subsequent activity, then designating the particular resource as a final cost object, and if the particular resource is required by a subsequent activity, classifying the resource as an Internal Resource and probing any other activity requiring this particular resource; and recording such designations and/or classification to the model interface; and
(v) Establishing that all required resources have been modeled, by operation of the computer application.

45. The computer system claimed in claim 37, wherein:
(a) the computer system is further operable to define for, and link to, each required resource a temporal state block, wherein the state of an activity can be derived automatically from the state(s) of the required resources for that activity; and
(b) the computer system is further operable to define one or more activity clusters consisting of an activity, one or more associated resources, at least one state block for each such resource, and at least one state junction corresponding to each of the at least one state block, the state junction defining whether the relationship between the at least one state block and the activity is conjunctive or disjunctive, and to apply a plurality of temporal and/or structural validity rules to the cluster so as to enable the aggregation of the states of the plurality of activities to define a temporal profile for the activity, and deriving from such temporal profile cost information regarding.

46. The computer system claimed in claim 45, wherein the computer application defines an auto-morphing routine that is operable on the computer to, in response to a state block change, apply a plurality of rules defining dependencies of states on resource attributes, thereby enabling the automatic updating of data populated to the Temporal Activity Based Costing Model.

47. The computer system claimed in claim 46, wherein the computer application further defines an auto-generation routine on the computer, such that the computer is operable to create state blocks and state junctions automatically for the activities and resources.

48. A computer program for enabling temporal, activity-based cost modeling comprising, for use on a computer, the computer application comprising:
(a) A computer useable medium; and
(b) Computer instructions on the computer useable medium, such computer instructions being operable on the computer to define a computer application that includes a profit knowledge utility, the profit knowledge utility being operable to:
(i) Process data elements corresponding to a plurality of data types contributing to costs related to one or more activities of the organization, so as to create an ontological enterprise model based on the data elements, by:
(A) applying a Temporal Activity Based Costing Model to the organization by means of a modeling utility;
(B) enabling a user to test the applicability of the Temporal Activity Based Costing Model to the organization; and
(C) further enabling the adjustment of the Temporal Activity Based Costing Model to the organization, based on (ii); and
(D) Applying the ontological enterprise model to the data elements on an ongoing basis, such that the ontological enterprise model yields cost information regarding the costs of the activities for defined periods of time.

49. The computer program claimed in claim 48, wherein the profit knowledge utility is further operable to enable one or more users to do one or more of the following, via one or more graphic user interfaces:
(a) Defining strategies for improving resource utilization; and/or
(b) Defining improved pricing strategies from the perspective of profit realization.

50. The computer program as claimed in claim 48, wherein the computer instructions are further operable to define on the computer a profit information utility, wherein the profit information utility is operable to extract the data from one or more data sources including one or more of (a) a warehouse management system, (b) an order management system, (c) an accounting system, (d) a customer resource management system, (e) an ERP system, or (f) an external system such as the Internet, so as to derive cost information.

51. The computer program claimed in claim 48, wherein the profit knowledge utility is further operable to derive cost knowledge from the cost information.

52. The computer system claimed in claim 51, wherein the computer application defines on the computer a billing application or billing engine linked to the profit knowledge utility that is operable to create cost-based bills based on the cost information.
